(19) United States
(12) Patent Application Publication
(10) Pub. No.: US 2015/0211997 A1
(43) Pub. Date: Jul. 30, 2015

(54) LIGHTING DEVICE AND MICROSCOPE, AND LIGHTING METHOD AND OBSERVATION METHOD

(71) Applicant: NIKON CORPORATION, Tokyo (JP)

(72) Inventor: Fumihiro DAKE, Kawasaki-shi (JP)

(21) Appl. No.: 14/683,507

(22) Filed: Apr. 10, 2015

Related U.S. Application Data
(63) Continuation of application No. PCT/JP2013/077538, filed on Oct. 9, 2013.

(30) Foreign Application Priority Data
Oct. 12, 2012 (JP) 2012-227503

(51) Int. Cl. G01N 21/64; G02F 1/11; G02F 1/21

(52) U.S. Cl. CPC G01N 21/64; G02F 1/21; G02F 1/11; G01N 2201/063

(57) ABSTRACT

An illumination apparatus including: a traveling wave forming unit that is disposed in an optical path of a light flux emitted from a light source unit and that is configured to form a sonic traveling wave in a direction traversing the emitted light flux; and an illumination optical system that is configured to form, on a plane to be observed, position-variable interference fringes caused by a plurality of diffracted light beams generated from the traveling wave forming unit.

### CROSS-REFERENCE TO RELATED APPLICATION

Priority is claimed on Japanese Patent Application No. 2012-227503, filed on Oct. 12, 2012. This application is a continuation application of International Patent Application No. PCT/JP2013/077538, filed on Oct. 9, 2013. The contents of the above-mentioned application are incorporated herein by reference.

### BACKGROUND

The present invention relates to an illumination technique for illuminating a plane to be observed of a specimen or sample, and a microscope and observation technique for observing a specimen or sample.

Numerous microscopic methods that exceed the resolution limit of optical microscopes have been proposed in recent years. These microscopes are generally called super-resolution optical microscope. One type of super-resolution optical microscope is a microscope that uses so-called structured illumination (structured illumination microscope). In this type of microscope, a striped fringe pattern (structured illumination) is projected on a plane to be observed of a specimen or sample (specimen plane or sample plane), and fluorescence excited thereby (or any light emitted from the specimen, such as scattering) is acquired by an imaging element. Constructing a super-resolution image requires acquisition of a plurality of images with fringe patterns (structured illumination) of different phases. By analyzing this plurality of images, a super-resolution image exceeding the resolution limit of the image-forming optical system for observation is acquired. Further, to realize super-resolution within a two-dimensional plane, the orientation of the structured illumination also needs to be varied.

By projecting structured illumination onto a specimen plane, the spatial frequency of the structured illumination and the spatial frequency of the specimen produce a moiré fringe. This moiré fringe contains spatial frequency information of the specimen, which has been frequency-converted to a low spatial frequency and exceeds the resolution limit of the image-forming optical system. If the spatial frequency of the moiré fringe is lower than the spatial frequency of the resolution limit of a typical image-forming optical system, that information can be detected by that image-forming optical system. Therefore, super-resolution can be realized by acquiring images containing the moiré fringe information and performing calculation processing using a plurality of images acquired while shifting the phase of the structured illumination (for example, refer to U.S. Pat. No. 6,239,909.

U.S. Pat. No. 6,239,909 disclose an example in which a structured illumination microscope is applied to a fluorescent observation. In the method of U.S. Pat. No. 6,239,909, a light flux emitted from a coherent light source is split into two light fluxes by a diffraction grating, and those two light fluxes are individually condensed at mutually different positions on a pupil of an objective lens. At this time, the two light fluxes are emitted from the objective lens as collimated light fluxes with different angles, and overlap each other on a specimen plane to form striped interference fringes (structured illumination). Further, in the method of U.S. Pat. No. 6,239,909, images of a specimen are repeatedly acquired while shifting the phase of the structured illumination stepwise, and calculation (separating calculation) for separating a structure of the specimen from patterns of the diffraction grating and calculation (demodulating calculation) for demodulating a super-resolution image from the plurality of images which has been separated are performed on the acquired plurality of images.

U.S. Pat. No. 6,239,909 also proposes a technique for using three light fluxes as the light flux that contributes to the interference fringes, in order to acquire a super-resolution effect along both the direction within the specimen plane and the depth direction, as an application of the method disclosed in U.S. Pat. No. 6,239,909. This is because, if three light fluxes are used, a striped pattern of structured illumination can be generated not only in the direction within the specimen plane but also in the depth direction.

### SUMMARY

However, among conventional methods for varying the phase of structured illumination stepwise, in a method in which an optical element such as a diffraction grating is moved stepwise, it is difficult to reduce the time required to acquire all required images (observation time) because a certain time is required to make the optical element that has been moved still at a proper position. Particularly, when the specimen is an organism specimen, it is preferable to acquire images as quickly as possible because there is a possibility that the structure of the specimen will change over time.

Furthermore, in conventional methods for acquiring a super-resolution effect along both the direction within the specimen surface and the depth direction using three light fluxes, there is a particularly great need to increase the speed of image acquisition because a large number of images are required in the above-mentioned separating calculation.

The aspects of the present invention are capable to switch the phase of structured illumination at high speed and with high precision.

According to a first aspect of the present invention, provided is an illumination apparatus including: a traveling wave forming unit that is disposed in an optical path of a light flux emitted from a light source unit and that is configured to form a sonic traveling wave in a direction traversing the emitted light flux; and an illumination optical system that is configured to form, on a plane to be observed, position-variable interference fringes caused by a plurality of diffracted light beams generated from the traveling wave forming unit.

According to a second aspect of the present invention, provided is a microscope for observing a plane to be observed, the microscope including: the illumination apparatus of the first aspect that is configured to illuminate the plane to be observed; an image-forming optical system that is configured to form images by a light beam generated from the plane to be observed; an imaging element that is configured to detect the image formed by the image-forming optical system; and a calculating unit that is configured to process information on the plurality of images detected by the imaging element in order to determine an image of the plane to be observed.

According to a third aspect of the present invention, provided is an illumination method for illuminating a plane to be observed, including the steps of: emitting a light beam from a light source unit; and forming, on the plane to be observed, phase-variable interference fringes constituted by a plurality of diffracted light beams generated from a traveling wave forming unit. The traveling wave forming unit is disposed in an optical path of an emitted light flux and having a sonic traveling wave formed in a direction traversing the emitted light flux.

According to a fourth aspect of the present invention, provided is an observation method for observing a plane to be observed, including the steps of: illuminating the plane to be observed by the illumination method of the third aspect; forming images via an image-forming optical system by a light beam generated from the plane to be observed; detecting the images formed by the image-forming optical system; and processing information on the detected plurality of images to determine an image of the plane to be observed.

According to the aspects of the present invention, because interference fringes by a plurality of diffracted light beams generated from a traveling wave forming unit which forms a sonic traveling wave can be used as structured illumination, the phase of the structured illumination can be switched at high speed and with high precision.

### BRIEF DESCRIPTION OF THE DRAWINGS

FIG. 1A illustrates a schematic configuration of a microscope pertaining to a first embodiment.

FIG. 1B illustrates a mask in FIG. 1A and masks of modified examples.

FIG. 2 illustrates an example of the relationship between a traveling wave and the period of a pulsed light beam.

FIG. 3 illustrates an example of the positional relationship between a traveling wave and a pulsed light beam over time.

FIG. 4A illustrates structured illumination (interference fringes) formed on a specimen plane at time point t₁.

FIG. 4B illustrates structured illumination (interference fringes) formed on a specimen plane at time point t₄.

FIG. 5A illustrates the relationship between a traveling wave and the period of pulsed light beam when performing three-phase structured illumination.

FIG. 5B illustrates the positional relationship between a traveling wave and a pulsed light beam at three points in time.

FIG. 5C illustrates structured illumination formed on a specimen plane at three points in time.

FIG. 6A illustrates the relationship between a traveling wave and the period of a pulsed light beam when performing five-phase structured illumination.

FIG. 6B illustrates the positional relationship between a traveling wave and a pulsed light beam at five points in time.

FIG. 6C illustrates structured illumination formed on a specimen plane at five points in time.

FIG. 7 illustrates an acousto-optic modulator (AOM) capable of generating traveling waves in three directions.

FIG. 8 illustrates essential parts of a microscope pertaining to a second embodiment.

FIG. 9 illustrates the principle of switching.

FIG. 10A illustrates the relationship between an input pulsed light beam and an output pulsed light beam in phase 1 mode.

FIG. 10B illustrates the relationship between an input pulsed light beam and an output pulsed light beam in phase 2 mode. FIG. 10C illustrates the relationship between an input pulsed light beam and an output pulsed light beam in phase 3 mode.

FIG. 11A illustrates the relationship between an output pulsed light beam and a traveling wave in phase 1 mode.

FIG. 11B illustrates the relationship between an output pulsed light beam and a traveling wave in phase 2 mode.

FIG. 11C illustrates the relationship between an output pulsed light beam and a traveling wave in phase 3 mode.

FIG. 11D illustrates structured illumination on a specimen plane in the three modes.

FIG. 12A illustrates a switching unit in phase 1 mode of a third embodiment.

FIG. 12B illustrates structured illumination on a specimen plane.

FIG. 13A illustrates a switching unit in phase 2 mode.

FIG. 13B illustrates structured illumination on a specimen plane.

FIG. 14A illustrates a switching unit in phase 3 mode.

FIG. 14B illustrates structured illumination on a specimen plane.

FIG. 15 illustrates essential parts of a microscope pertaining to a fourth embodiment.

FIG. 16A illustrates the relationship between an input pulsed light beam and an output pulsed light beam in phase 1 mode.

FIG. 16B illustrates the relationship between an input pulsed light beam and an output pulsed light beam in phase 2 mode.

FIG. 16C illustrates the relationship between an input pulsed light beam and an output pulsed light beam in phase 3 mode.

FIG. 16D illustrates structured illumination on a specimen plane in the three modes.

FIG. 16E illustrates the relationship between an applied voltage to an electro-optic element (EOM) and time, for realizing the states of FIGS. 16A, 16B, and 16C.

FIG. 17A illustrates the operation of an AOM of a fifth embodiment.

FIG. 17B illustrates a control unit of the AOM.

FIG. 18A illustrates the relationships between a pulsed light beam and a traveling wave, and structured illumination in phase 1 mode.

FIG. 18B illustrates the relationships between a pulsed light beam and a traveling wave, and structured illumination in phase 2 mode.

FIG. 18C illustrates the relationships between a pulsed light beam and a traveling wave, and structured illumination in phase 3 mode.

FIG. 19A illustrates a laser light beam of a sixth embodiment.

FIG. 19B illustrates a driving signal applied to an AOM of a sixth embodiment.

FIG. 19C illustrates the timing of image-taking by an imaging element of a sixth embodiment.

FIG. 20A illustrates the relationships between a continuous light beam and a traveling wave, and structured illumination in phase 1 mode.

FIG. 20B illustrates the relationships between a continuous light beam and a traveling wave, and structured illumination in phase 2 mode.

FIG. 20C illustrates the relationships between a continuous light beam and a traveling wave, and structured illumination in phase 3 mode.

FIG. 21 illustrates essential parts of a microscope pertaining to a seventh embodiment.

FIG. 22A illustrates the phase relationships of a +first-order light beam, a −first-order light beam, and structured illumination and the like. FIG. 22B illustrates the phase relationships of a +first-order light beam, a −first-order light beam, and structured illumination and the like.

FIG. 22C illustrates the phase relationships of a +first-order light beam, a −first-order light beam, and structured illumination and the like.

FIG. 23A illustrates the relationships of a +first-order light beam, a −first-order light beam, and structured illumination when the −first-order light beam has been phase-modulated.

FIG. 23B illustrates the relationships of a +first-order light beam, a −first-order light beam, and structured illumination when the −first-order light beam has been phase-modulated.

FIG. 24A illustrates the correspondence relationship between an image and a Fourier-transformed image.

FIG. 24B illustrates the correspondence relationship between an image and a Fourier-transformed image.

FIG. 24C is an explanatory diagram of a method for reconstructing an image by inverse Fourier transform.

FIG. 25 is a flowchart illustrating an example of an illumination method and an observation method.

FIG. 26 illustrates a schematic configuration of a microscope pertaining to an eighth embodiment.

FIG. 27A illustrates an example of a variable delay circuit 56 in FIG. 26.

FIG. 27B is a timing chart for explaining phase delay caused by the inverter in FIG. 27A.

FIG. 27C illustrates the relationship between delay time and exposure quantity.

FIG. 28A illustrates the state of synchronization between the repetition frequency of a pulsed light beam and the frequency of a traveling wave in an AOM.

FIG. 28B illustrates an example of the relationship between the number of images acquired and phase difference.

FIG. 29A is a flowchart illustrating an example of a frequency control method.

FIG. 29B is a flowchart illustrating another example of the frequency control method.

FIG. 30 illustrates a schematic configuration of a microscope pertaining to a ninth embodiment.

FIG. 31A is a diagram for explaining of a method for detecting a frequency error.

FIG. 31B illustrates an example of the relationship between the frequency of a traveling wave in the AOM and image contrast.

### DESCRIPTION OF EMBODIMENTS

### First Embodiment

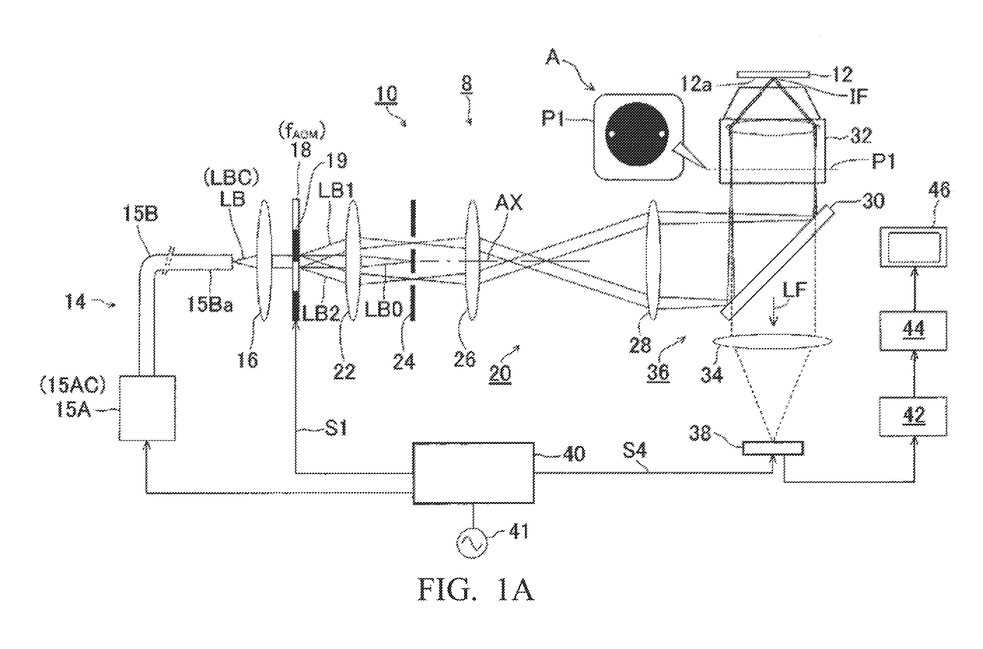

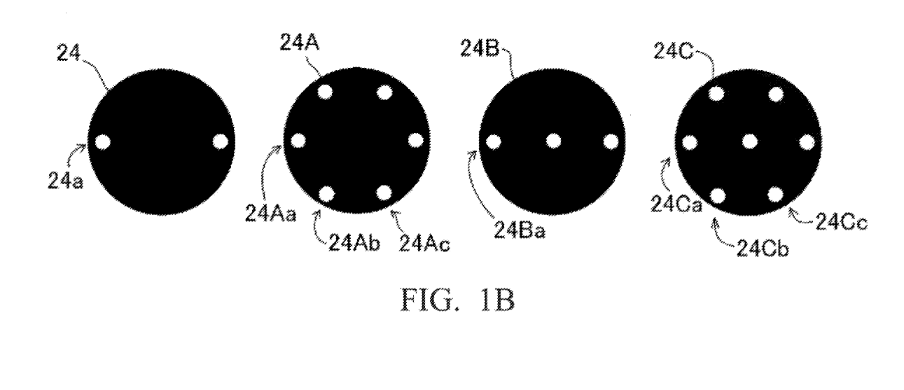

A first embodiment of the present invention will be described in reference to FIGS. 1A to 7. FIG. 1A illustrates a schematic configuration of a microscope 8 pertaining to the first embodiment. As an example, the microscope 8 is a microscope that performs a fluorescent observation using structured illumination which will be described in detail below. An object to be observed by the microscope 8 is a specimen 12, such as an organism specimen including a cell, labeled with a fluorescent reagent. The specimen 12 is held on a positionable table (not illustrated), and a surface of the specimen 12 on which the fluorescent reagent has been applied (specimen plane 12a) is a plane to be observed.

In FIG. 1A, the microscope 8 has an illumination apparatus 10 for illuminating the specimen plane 12a, an image-forming optical system 36 for forming an image by fluorescence LF generated from the specimen plane 12a, a two-dimensional CCD or CMOS imaging element 38 for detecting that image, a storage apparatus 42 for storing information on a plurality of images detected by the imaging element 38, and a calculating apparatus 44 for processing information read from the storage apparatus 42 to determine information on an image having a structure (super-resolution) exceeding the resolution of the image-forming optical system 38. The image determined by the calculating apparatus 44 is displayed on a display apparatus 46 as an example.

The illumination apparatus 10 has a light source system 14 for emitting a light pulse LB having coherence in the wavelength range that can excite the fluorescent reagent, an acousto-optic modulator (AOM) 18 for generating a sonic traveling wave 19 for diffracting the emitted light pulse LB, and a condensing optical system 20 (illumination optical system) for guiding a plurality of diffracted light beams generated from the acousto-optic modulator (for example, ±first-order light beams LB1, LB2, or a zero-order light beam LB0 and ±first-order light beams LB1, LB2, or the like) to the specimen plane 12a and forming structured illumination IF constituted by variable-phase interference fringes. The optical axis of the condensing optical system 20 is taken as AX. Hereinafter, an acousto-optic element or an acousto-optic modulator is called an AOM. The AOM 18 is constituted by a substrate which is made of a photoelastic crystal, such as tellurium dioxide, lead molybdate or quartz, and to which a piezoelectric element for generating a sonic wave (ultrasonic wave) is attached. The illumination apparatus 10 has a control apparatus 40 for controlling the operation of the light source system 14 and the AOM 18. A signal generator 41, which can, for example, output an alternating current (AC) signal (periodic signal) of a prescribed frequency, is connected to the control apparatus 40. Furthermore, as the light pulse LB having coherence, a pulse-oscillated laser light beam, such as the second or third harmonic of a YAG laser (with a wavelength of approximately from 300 to 500 nm), a pulse-oscillated metal vapor laser (with a wavelength of approximately from 400 to 500 nm) or the like, may be used.

The light source system 14 has a coherent light source 15A such as a laser light source which generates a light pulse (pulsed light) LB having coherence; an optical fiber 15B which transmits the light pulse LB; and a lens 16 by which the light pulse LB emitted from an end portion 15Ba of the optical fiber 15B are incident on the substrate of the AOM 18 having the traveling wave 19 formed therein. The AOM 18 functions as a phase-type diffraction grating which moves in a specified direction in order to generate a refractive index distribution at the frequency of a sonic wave by the traveling wave 19. The interaction between the light pulse LB and the AOM 18 will be described in detail below,

The zero-order light beam LB0, ±first-order light beams LB1, LB2, and a higher order diffracted light beam (not illustrated) are generated by the light pulse LB diffracted by the AOM 18. These types of diffracted light beams are condensed by a lens 22 at a position on a mask 24 (mask position) that depends on a diffraction angle.

When the height from the optical axis AX (condensation position) on the mask 24 is taken as y, the focal length of the lens 22 is taken as f₂, and the diffraction angle is taken as 0, the relational equation y=f₂ sin θ holds true. The mask 24 is configured so as to selectively pass a diffracted light beam only which forms an image at a desired position, and in the case illustrated in FIG. 1A, the mask 24 passes only ±first-order light beams LB1, LB2, In this case, a pair of apertures 24a is formed in the mask 24 as illustrated in FIG. 1B. Furthermore, when, for example, structured illumination IF having periodicity is sequentially generated in three directions set at equiangular spacing around the optical axis, a mask 24A having three pairs of apertures 24Aa, 24Ab, 24Ac formed therein may be used with the AOM 18 rotatable. Because this mask 24A can be in the fixed state, the condensing optical system 20 can be simplified. However, the mask 24 may also be rotatable in a case where an excess diffracted light beam or stray light beam is present. This is the same for the case of three-light flux interference below.

The mask 24 is disposed at a position conjugated with a pupil plane P1 of a first objective lens 32 to be described later, and the plurality of diffracted light beams that has passed through the mask 24 is relayed to the pupil plane P1 (pupil) of the first objective lens 32 via a pair of lenses 26, 28 and a wavelength-selective dichroic minor 30. Therefore, an intensity distribution as illustrated by A in FIG. 1A is formed on the pupil plane P1. The dichroic mirror 30 has wavelength selectivity to reflect the light pulse LB (diffracted light beam) and to pass fluorescence LF generated on the specimen plane 12a. The plurality of diffracted light beams incident on the pupil plane P1 is condensed on the specimen plane 12a by the first objective lens 32, and the specimen plane 12a is illuminated by the structured illumination IF constituted by interference fringes formed by the plurality of diffracted light beams. Fluorescence LF excited by the structured illumination IF is generated on the specimen plane 12a.

The condensing optical system 20 is constituted by the lens 22, the mask 24, the lenses 26, 28, the dichroic mirror 30, and the first objective lens 32. The formation plane of the traveling wave 19 of the AOM 18 and the specimen plane 12a are optically conjugated by the condensing optical system 20. Furthermore, the optical system that transmits light pulse LB from the coherent light source 15A is not limited to the optical fiber 15B, and may be an optical system that propagates the pulsed light beam through space via a plurality of mirrors or the like.

Also, only ±first-order light beams are selected when the mask 24 selects diffracted light beams, but this embodiment is not limited to this application. Additionally, with the addition of a zero-order light beam LB0, the structured illumination IF may be generated by three-light flux interference. By generating the structured illumination IF by three-light flux interference, a super-resolution effect can be provided in the optical axis direction as well. As a mask that selects the zero-order light beam and ±first-order light beams, a mask 24B of FIG. 1B in which three apertures 24Ba are formed in a row may be used. Furthermore, when, for example, structured illumination IF having periodicity is sequentially generated in three directions set at equiangular spacing around the optical axis, a mask 24C having three pairs of apertures 24Ca, 24Cb, 24Cc formed therein may be used in the fixed state.

Here, structured illumination that uses two-light flux interference is defined as two-light flux mode, and structured illumination that uses three-light flux interference is defined as three-light flux mode. These definitions will be used in the descriptions below.

The fluorescent reagent of the specimen 12 excited by the structured illumination IF generates fluorescence. The fluorescence is isotropically generated, but, of the fluorescence generated from the specimen 12, fluorescence LF detected by the first objective lens 32 passes through the dichroic mirror 30 and forms an image of the specimen plane 12a on a light receiving plane of the imaging element 38 by an objective lens 34, and this image is taken by the imaging element 38. The image at this time is an image having a moiré pattern which is generated by the spatial frequency of the structured illumination IF and the spatial frequency of the specimen 12. The image-forming optical system 36 is constituted by objective lenses 32, 43 and the dichroic mirror 30. The specimen plane 12a and the light receiving plane of the imaging element 38 are optically conjugated in the image-forming optical system 36. The control apparatus 40 synchronously drives the AOM 18 and the coherent light source 15A via a driving signal S1 or the like, and controls the image-taking operation of the imaging element 38 via a control signal S4.

At this time, the control apparatus 40 synchronizes the frame rate of the imaging element 38 with the repetition frequency fᵣₑₚ of the light pulse LB, whereby specimen images excited by the structured illumination IF of different fringe phases can be acquired at high speed (for example, at a speed several times higher than the repetition frequency fᵣₑₚ). This timing synchronization will be described in detail later.

A super-resolution image can be generated by varying the phase and orientation of the structured illumination IF so as to acquire a number of images of the specimen 12 required to generate a super-resolution image, and by performing prescribed image processing on the images of the specimen 12 by the calculating apparatus 44. The method for varying the phase of the structured illumination IF will be described later together with the method for synchronizing the timing of the imaging element 38 and the light pulse LB. The method for varying the orientation of the structured illumination IF will also be described later.

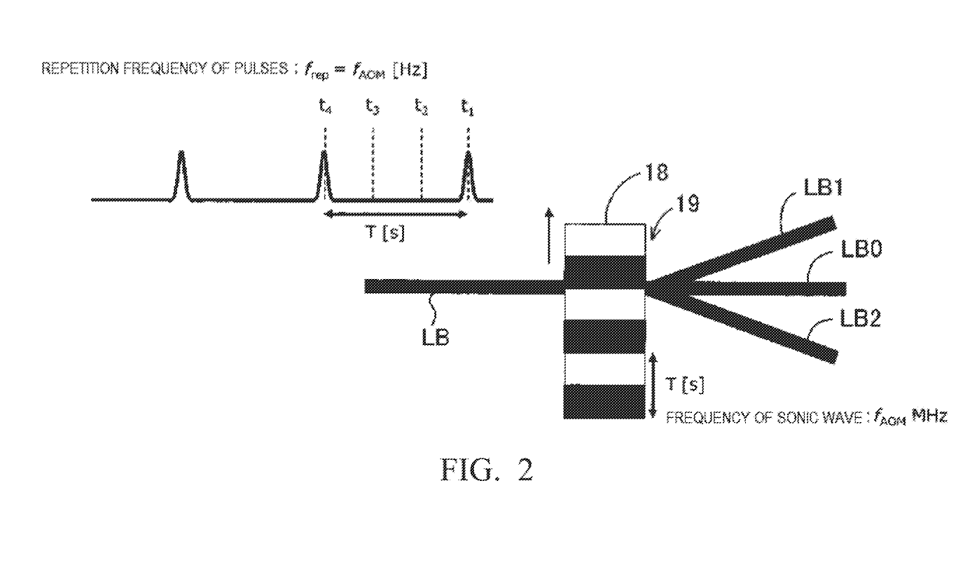

Next, the details of the interaction between the light pulse LB and the AOM 18 will be described in detail. In this embodiment, as illustrated in FIG. 2, the repetition frequency fᵣₑₚ of the light pulse LB and the frequency f_{AOM} of the traveling wave 19 (sonic wave) of the AOM 18 are synchronized. A photoelastic effect causes the AOM 18 to generate coarseness and fineness of the refractive index distribution with the frequency of the sonic wave. The coarseness and fineness of this refractive index distribution can be considered as a phase-type diffraction grating. The refractive index distribution varies with time by the traveling-wave-type AOM 18. In short, when space is fixed and time is varied, the coarseness and fineness of the refractive index varies continuously and periodically with time. The time period of the variation in refractive index distribution is taken as T, it becomes T=1/f_{AOM}. When the speed of sound in the AOM 18 is taken as v, the pitch p of the phase-type diffraction grating formed by a sonic wave in the AOM 18 is determined by the velocity v of the sonic wave and the frequency f_{AOM} of the sonic wave, as follows:

p=v·T=v/f_{AOM} (1)

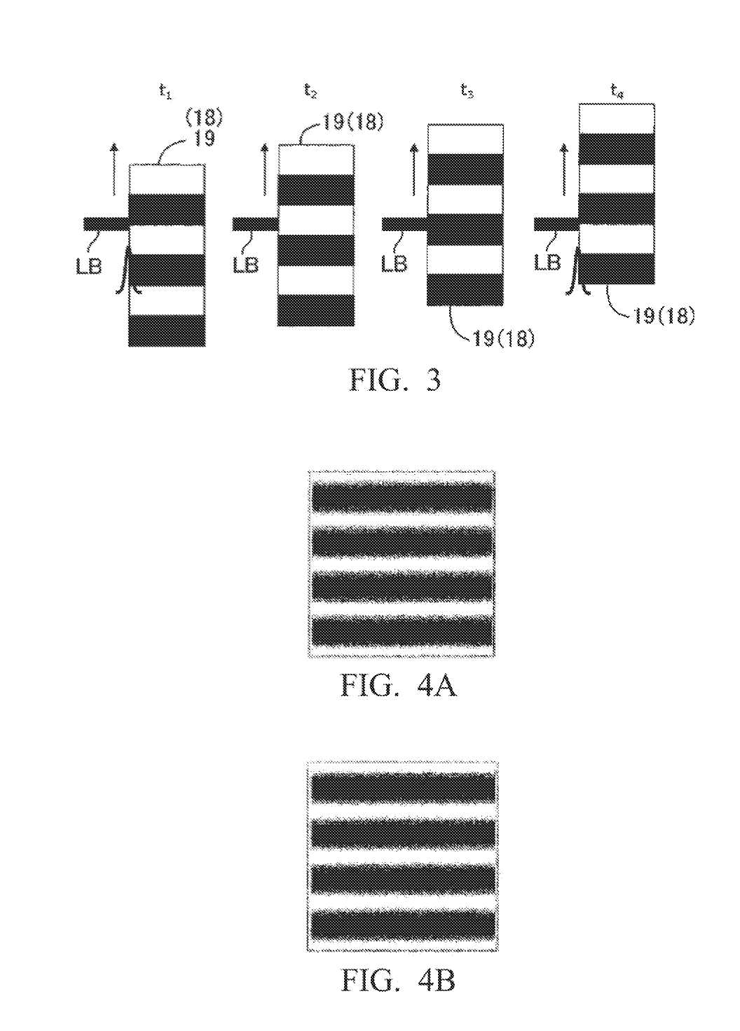

Here, as illustrated in FIG. 2, when fᵣₑₚ=f_{AOM} is satisfied, the repetition period of the light pulse LB is naturally also T. In this case, when individual light pulses LB reach the AOM 18, the phase of the diffraction grating sensed by the light pulses LB is always constant. That is, for the light pulses LB, the diffraction grating appears to be still. FIG. 3 illustrates a situation when the light pulses LB generated at time points t₁, t₂, t₃, t₄ set at equal time intervals during one period T in FIG. 2 are incident on the AOM 18. Over time, the phase-type diffraction grating (traveling wave 19) generated by the AOM 18 shifts in a direction perpendicular to the optical axis. In short, it is seen that the phase of the diffraction grating varies. Because the time difference between time points t₁ and t₄ is equal to the shift time T of one period of the phase-type diffraction grating of the AOM 18, the phase of the fringes of the diffraction grating relative to the light pulses LB is the same at time points t₁and t₄. Furthermore, for example, the light pulse LB generated at time point t₁ includes a series of light pulses LB generated at time points t₁, t₁+T, t₁+2T, . . . .

Because the diffraction grating formation surface of the AOM 18 has a conjugate relation with the specimen plane 12a, a sinusoidal intensity pattern (structured illumination IF) corresponding to the phase of the diffraction grating is generated on the specimen plane 12a. FIGS. 4A and 4B illustrate structured illumination patterns generated on the specimen plane 12a by the light pulses LB at time points t₁ and t₄ illustrated in FIG. 3. It is seen that the light pulses LB at time points t₁ and t₄ form completely the same structured illumination.

In this way, by synchronizing the frequency f_{AOM} of the traveling wave 19 of the AOM 18 and the frequency fᵣₑₚ of the light pulse LB, it is possible that the diffraction grating that varies at frequency f_{AOM} in the AOM 18 be configured so as to appear to be still relative to the light pulses LB, and in this case, the structured illumination IF is also still. By varying the phase of the light pulse LB, it is possible to vary the timing with which the light pulse LB is incident on the diffraction grating in the AOM 18; therefore, it is possible to vary the phase of the diffraction grating and to vary the phase of the structured illumination IF formed on the specimen plane 12a.

Next, the method for varying the interference fringes of structured illumination at high speed and the relationship between the repetition frequency of the light pulse LB and the timing of image-taking by the imaging element 38 will be described. Here, the repetition frequency fᵣₑₚ of the light pulse LB is set to an integral multiple of the frequency f_{AOM} of the AOM 18 as follows. Here m is an integer.

fᵣₑₚ=m·f_{AOM} (2)

Additionally, as an example, a case where the phase of the interference fringes generated by structured illumination is varied one-third of a period at a time and three images of different phases are acquired will be considered. When the pitch of the phase-type diffraction grating generated in the AOM 18 is taken as p, the quantity of position variation for one-third of a period is p/3. When this is converted to phase quantity, it becomes 2π/3 rad. The unit “rad” will be omitted hereinafter. Furthermore, at this time, the zero-order light beam LB0 of FIG. 1A is blocked. That is, two-light flux mode will be considered.

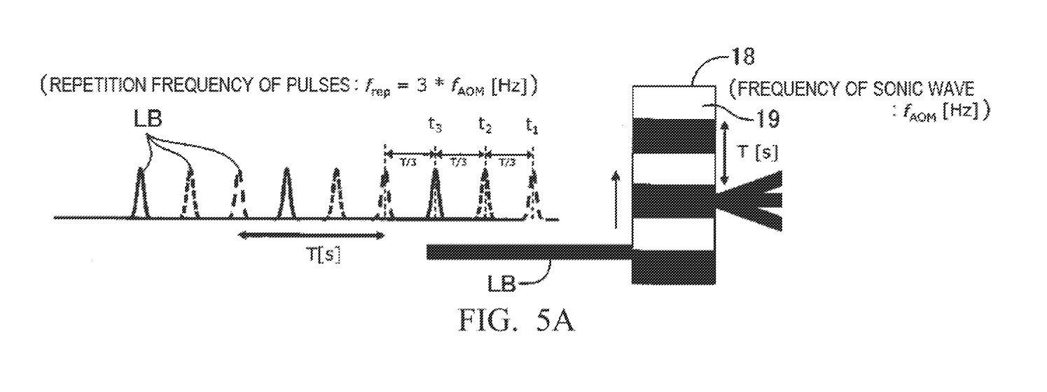

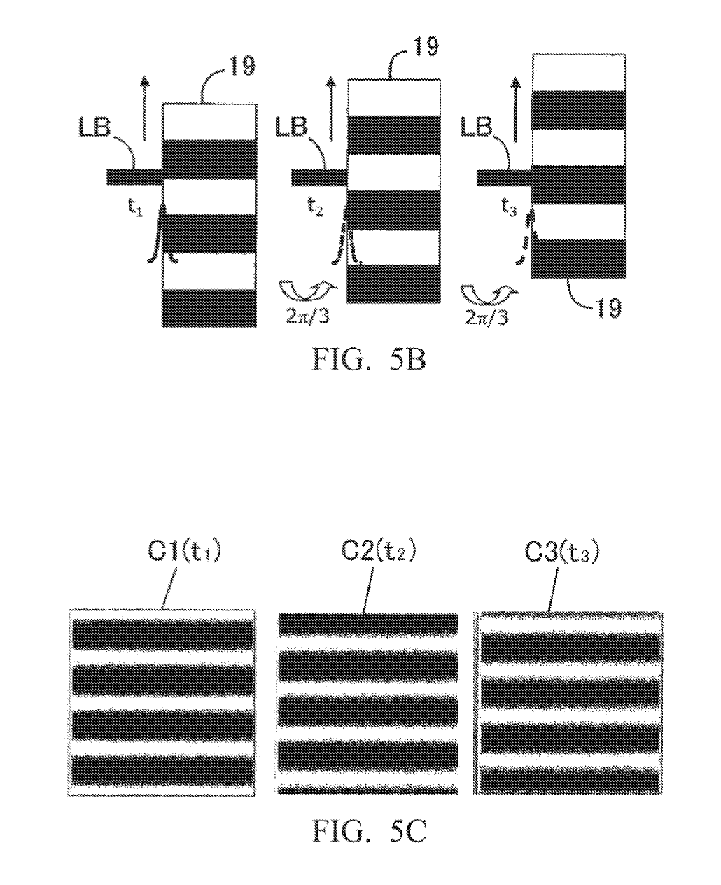

To realize this phase modulation, when m=3 in equation (2), it becomes fᵣₑₚ=3f_{AOM}. The relationship between the light pulse LB and the AOM 18 at this time is illustrated in FIG. 5A. When the time period of the diffraction grating is taken as T, the time intervals of time points t₁, t₂, t₃ at which each light pulse LB is generated is T/3. Therefore, while the diffraction grating in the AOM 18 travels one period, three light pulses LB are incident on the AOM 18 and are diffracted by the AOM 18. FIG, 5B illustrates the interaction between each of the light pulses LB and the AOM 18. Because the time interval of the light pulses LB is T/3, it is seen that the phase of the diffraction grating in the AOM 18 sensed by each of the light pulses LB shifts by one-third of a period at a time, that is, by 2π/3 at a time. The patterns of the structured illumination IF generated on the specimen plane 12a by the pulsed light beams generated at time points t₁, t₂, t₃ are illustrated with patterns C1, C2, C3 of FIG. 5C.

In this way, structured illumination of desired fringe phases can be generated on the specimen plane in accordance with the timing of the light pulse LB and the AOM 18.

Note that structured illumination by two-light flux mode has been considered here, and therefore, when the pitch of the diffraction grating in the AOM 18 is taken as p and the projection magnification of the optical system from the AOM 18 to the specimen plane 12a is taken as β, the pitch pₛ of the structured illumination IF on the specimen plane is as follows:

pₛ=(1/2)β·p (3)

Therefore, when the phase of the diffraction grating in the AOM 18 is varied by 2π/3 at a time as in this case, the phase shift of the structured illumination on the specimen plane 12a is twice that, or 4π/3.

In this way, since the specimen 12 is excited with structured illumination patterns of different phases, by the imaging element 38 taking an image of fluorescence LF thus generated, images required for the microscope 8 that uses structured illumination can be acquired at high speed without the necessity of mechanical driving of the diffraction grating, optical element or the like.

Here, control of the frame rate of the imaging element 38 and the repetition frequency of the light pulse LB will be described. To acquire images of different phases, as described using FIGS. 5A to 5C, individual light pulses need to be independently detected by the imaging element 38. Therefore, the frame rate fᵣ of the imaging element 38 needs to be equal to the repetition frequency fᵣₑₚ of the light pulse LB.

To realize this, for example, the repetition frequency of the light pulse LB may be used as the master frequency. In this case, some of the light pulses LB are detected by a light detector having a wide frequency range, such as a photodiode, and the detected light pulses are converted to an electrical signal. A trigger signal obtained by the control apparatus 40 processing the convertered electrical signal is supplied to the imaging element 38 as part of the control signal S4, and as a result, the imaging element 38 can take images in synchronization with the light pulses LB.

The control apparatus 40 receives an AC signal (containing an AC signal of frequency f_{AOM} and m·f_{AOM}, for example) from the signal generator 41, and drives the AOM 18 using the AC signal. Also, when the oscillation frequency of the signal generator 41 can be varied using the control apparatus 40, the pitch of the diffraction grating generated by the AOM 18 can also be varied.

Next, a case where structured illumination is generated using three-light flux interference (three-light flux mode) will be described. In this case, the mask 24 in FIG. 1A needs to be replaced with, for example, the mask 24B or 24C in FIG. 1B so as to pass the zero-order light beam LB0 therethrough. Furthermore, images of five phases per direction need to be acquired in order to construct a super-resolution image. Therefore, because m=5 in equation (2), the repetition frequency fᵣₑₚ of the light pulse LB becomes 5f_{AOM}.

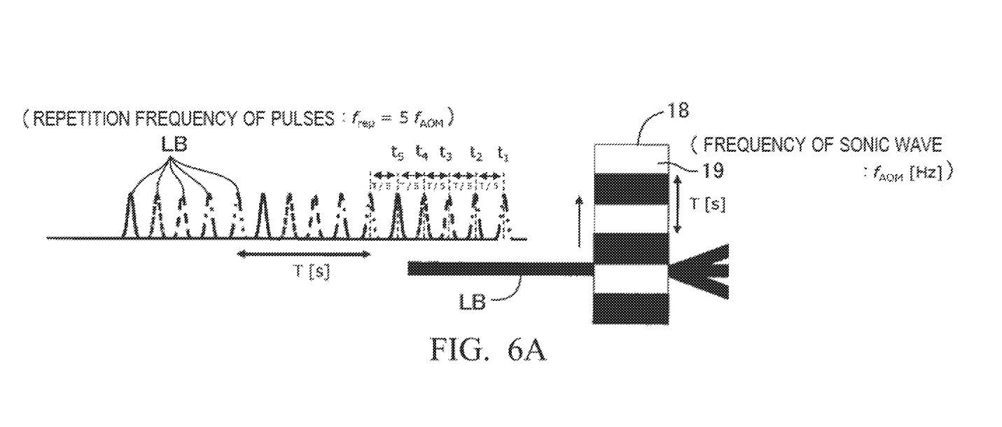

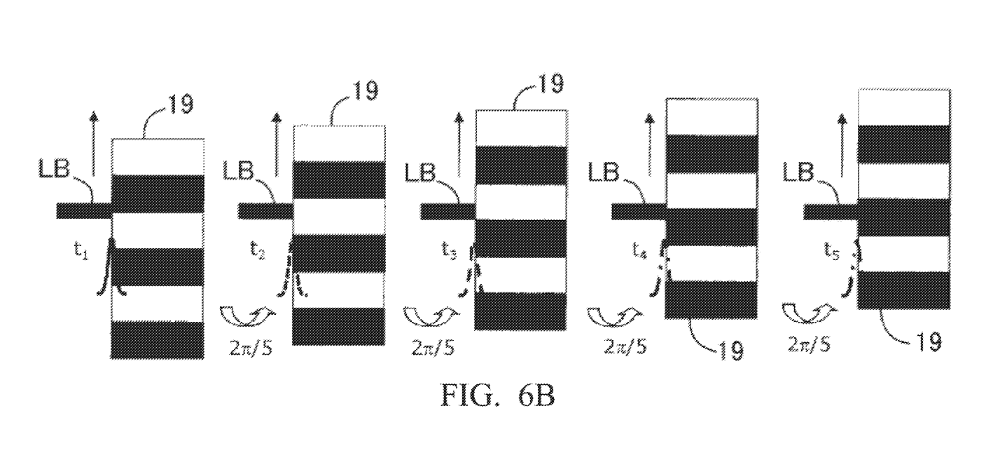

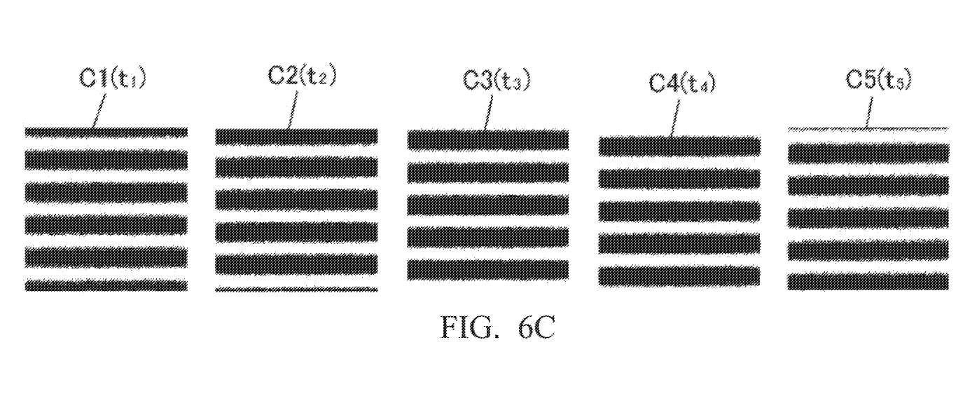

An overview of three-light flux mode will be described in reference to FIGS. 6A to 6C. It can be realized by the same configuration and processes as two-light flux mode, except that, because the value of m is varied, the repetition frequency of the light pulse LB is varied, and with that variation, the frame rate fᵣ of the imaging element 38 is varied. Here, descriptions of the same items will be omitted.

In the three-light flux mode, when the pitch of the diffraction grating in the AOM 18 is taken as p and the projection magnification of the condensing optical system 20 is taken as β, the pitch pₛ of structured illumination on the specimen plane has the following relationship:

psₛ=β·p (4)

Therefore, when the phase of the diffraction grating in the AOM 18 is varied by 2π/5 at a time, the phase shift of the structured illumination IF on the specimen plane 12a also becomes 2π/5.

Therefore, in three-light flux mode, as illustrated in FIG. 6A, when the time period of the diffraction grating (traveling wave 19) is taken as T, the time interval of time points t₁, t₂, t₃, t₄, t₅ at which the respective light pulses LB are generated becomes T/5. Therefore, while the diffraction grating in the AOM 18 travels one period, five light pulses LB are incident on and diffracted by the AOM 18. Because the time interval of the light pulses LB is T/5, as illustrated in FIG. 6B, the phase of the diffraction grating in the AOM 18 sensed by each of the light pulses LB shifts by one-fifth of a period at a time, that is, by 2π/5 at a time. The patterns of the structured illumination IF generated on the specimen plane 12a by the pulsed light beams generated at time points t₁ to t₅ are illustrated by patterns C1, C2, C3, C4, C5 in FIG. 6C. In this way, even in three-light flux mode, structured illumination of desired fringe phases can be generated on the specimen plane.

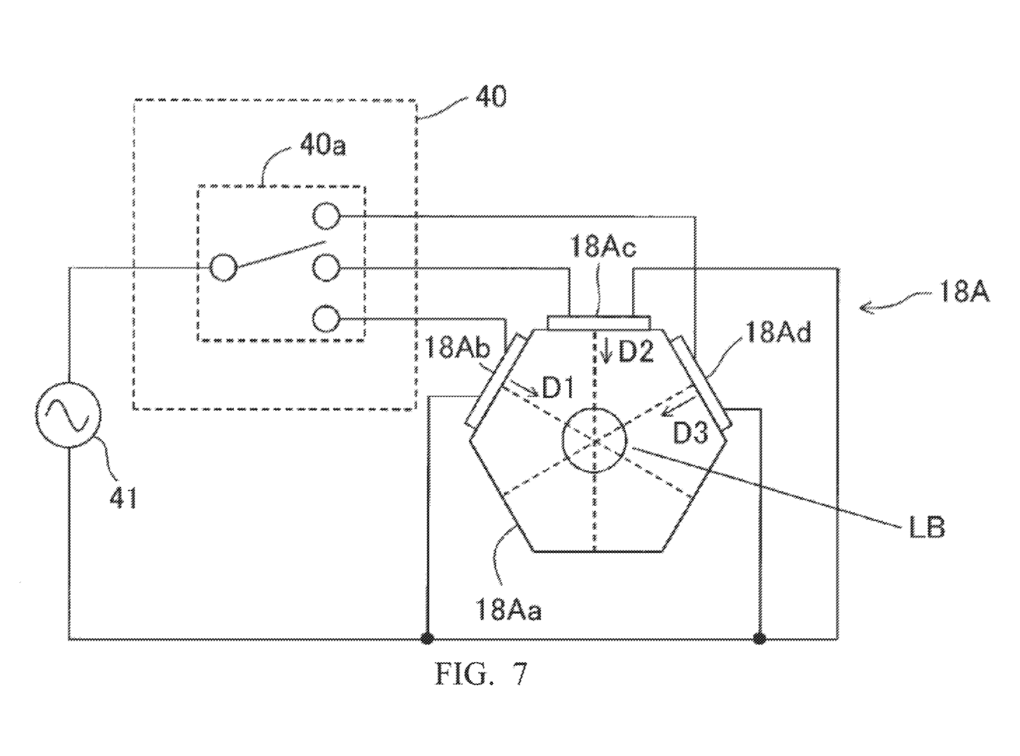

Up to now, high-speed switching of the phase of the structured illumination IF in this embodiment has been described. Next, direction switching of the structured illumination IF will be described. To do so, it is preferable to use an AOM 18A having a configuration with which piezoelectric elements (electrodes) 18Ab, 18Ac, 18Ad are provided in three directions D1, D2, D3 different substantially 120° from each other on a substrate 18Aa having a substantially regular hexagonal AOM effect, as illustrated in FIG. 7. The AOM 18A applies an electrical signal to each of the piezoelectric elements 18Ab, 18Ac, 18Ad to generate coarseness and fineness of the refractive index (traveling wave) in each of the directions D1 to D3 so that the coarseness and fineness of the refractive index traverses the optical path of the light pulse LB within the substrate 18Aa. As a result, a phase-type diffraction grating which varies in phase can be generated. Selecting the direction in which the diffraction grating is generated can be realized by providing the control apparatus 40 with a selection switch 40a that selectively applies an electrical signal to the piezoelectric elements 18Ab to 18Ad. Furthermore, an AOM that generates a traveling wave in two directions or four or more directions rather than three directions may also be used.

Rather than the AOM 18A or the like which is capable of generating a traveling wave in a plurality of directions, the AOM 18 may be mechanically rotated in order to realize a rotation of the orientation of the diffraction grating as shown in FIG. 1A. In this case, the speed is slower because physical driving is required, but production cost can be reduced and the AOM is easily available.

Furthermore, when a super-resolution effect is desired only in one specified direction, rotation of the AOM 18 is not necessary, and therefore the high-speed phase switching of this embodiment may be applied using an ordinary AOM.

Here, the required time for speeding up phase switching that can be realized by this embodiment will be estimated. When the frequency f_{AOM} of the sonic wave in the AOM 18 is taken as 10 MHz, the required repetition frequency fᵣₑₚ of the light pulse LB is 30 MHz in two-light flux mode and 50 MHz in three-light flux mode, as determined by equation (2). In the method of this embodiment, the phase can be varied by the repetition frequency of the light pulse LB.

The frame rate of the imaging element 38 is the same as the repetition frequency of the light pulse LB. This is obvious, considering the necessity of independently detecting individual light pulses LB. In the current state of the art, an imaging element for a high-speed imaging camera can be used as the imaging element 38 having such a frame rate. Considering the frame rate of ordinary imaging elements, the rate-limiting condition of the high-speed phase switching according to this embodiment is the frame rate of the imaging element 38, and the phase switching of the structured illumination IF can be performed at a speed higher than the frame rate.

When selecting the frequency of the AOM 18, it is necessary to take note of the relationship between its frequency f_{AOM} and the diffraction phenomenon that arises due to the phase-type diffraction grating in the AOM 18. When the frequency f_{AOM} is low (for example, around 10 MHz), Raman-Nath diffraction is dominant, and when the frequency f_{AOM} is high (for example, around 100 MHz), Bragg diffraction is dominant. The more the frequency f_{AOM} is increased, the higher the speed can be, but there is a problem that asymmetry in the diffracted light beam occurs by Bragg diffraction. In short, only one of the ±first-order light beams is produced. This is due to the fact that only a light beam that satisfies the Bragg condition is diffracted.

Therefore, in three-light flux mode, the frequency f_{AOM} of the AOM 18 needs to be set within the frequency band of Raman-Nath diffraction. In two-light flux mode, a higher-speed phase modulation is possible because not only can Raman-Nath diffraction be used, but Bragg diffraction can be used as well.

Here, the duration of the light pulse LB will be examined. Because a traveling-wave-type diffraction grating constantly shifts, it is preferable the duration of the pulsed light beam be short to make the diffraction grating appear to be still.

For example, the condition under which the diffraction grating is still is assumed to be when the pulse width τₚ is 1/1000 of the time period T of the diffraction grating. In this case, when f_{AOM}=10 MHz, it becomes T=1/f_{AOM}=100 ns. Therefore, it becomes τₚ=T/1000=100 ps. In short, it is sufficient if a pulse laser having a duration of 100 ps is used for the light pulse LB.

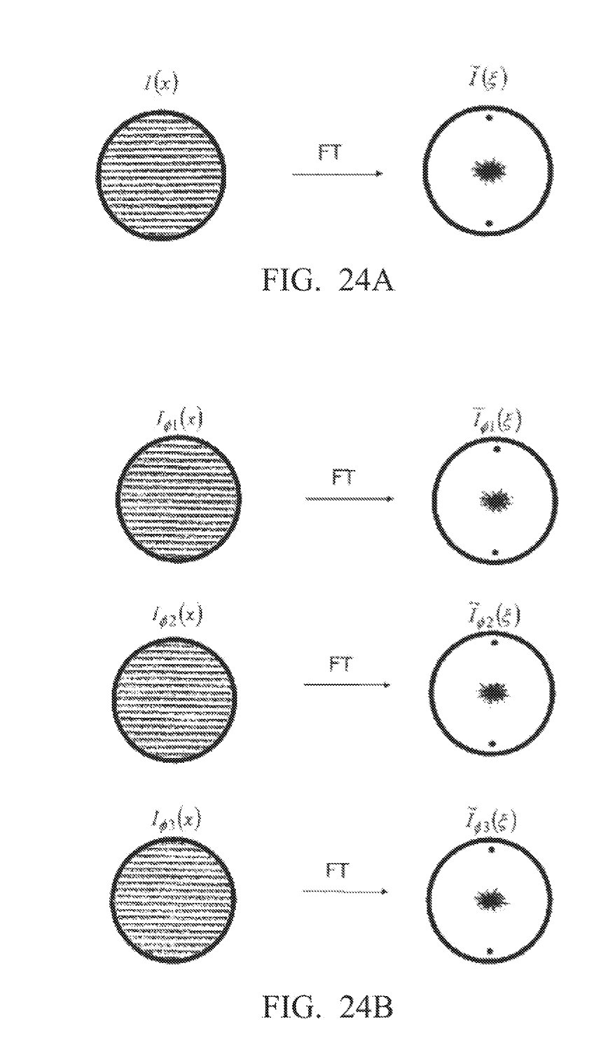

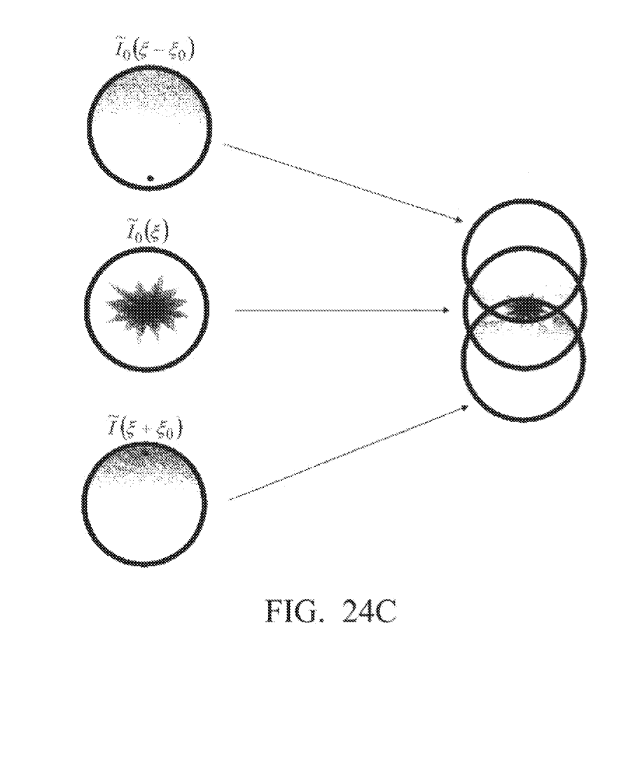

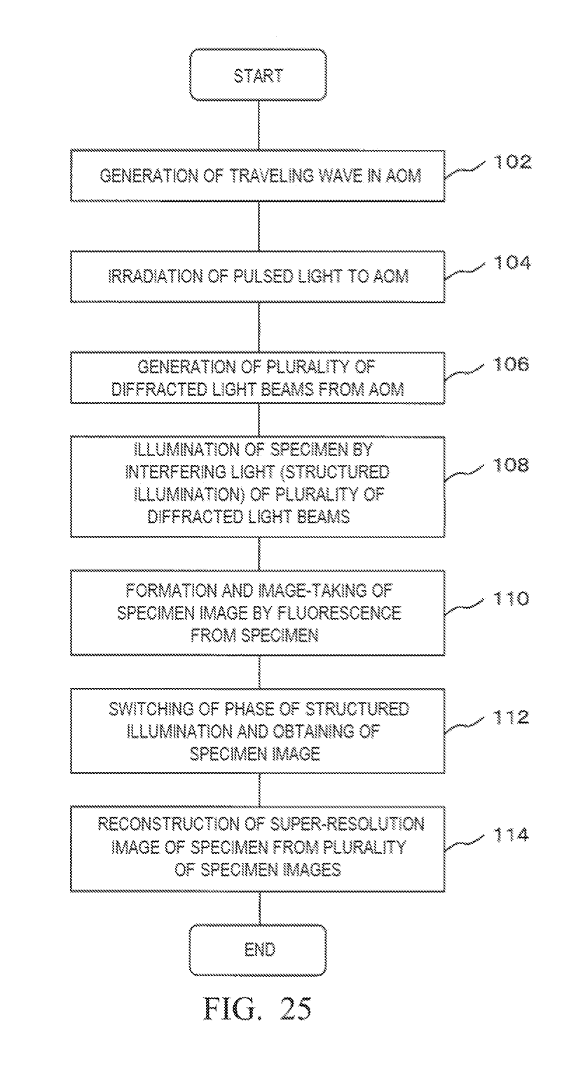

Next, an example of the method for acquiring a super-resolution image of the specimen 12 illuminated by the structured illumination IF by the illumination apparatus 10 in the microscope 8 of this embodiment will be described in reference to the flowchart of FIG. 25 and FIGS. 24A to 24C. First, the traveling wave 19 is generated in the AOM 18 (step 102 in FIG. 25), and the light pulse LB is irradiated from the light source system 14 to the AOM 18 (step 104). As a result, a plurality of diffracted light beams are generated from the AOM 18 (step 106), and these diffracted light beams form structured illumination IF constituted by interference fringes on the specimen plane 12a via the condensing optical system 20 (step 108). Fluorescence LF from the specimen 12 forms a specimen image on the imaging element 38 via the image-forming optical system 36, and that image is taken by the imaging element 38 with a prescribed timing (step 110).

When considering this case in one dimension for the sake of simplicity, when the position in the measurement direction on the specimen 12 (sample) is taken as x, the fluorescent substance density is taken as I₀(x), and the intensity distribution of the structured illumination IF on the specimen plane 12a is taken as K(x). When it is assumed that the fluorescence from the specimen 12 is proportional to the illumination intensity, the fluorescence density distribution I_{fl}(x) is as follows:

I_{fl}(x)=I₀(x)K(x) (21)

Because the fluorescence at each point on the specimen 12 is incoherent, image I(x) in which the fluorescence density distribution is captured by the image- forming optical system 36 is given according to the equation of incoherent image formation as follows. Here, PSF(x) is the point image distribution function of the image-forming optical system 36.

I(x)=∫∫dx′PSF(x−x′)I_{fl}(x) (22)

Here, when the Fourier transform of the function f(x) is taken as F[f(x)], the Fourier transform of the image I(x) is expressed by the following equation (22F), and when the Fourier transform of the function PSF(x) is taken as OTF(ξ), equation (22) becomes the following equation (23). However, the second function on the right side of equation (22) (Fourier transform of fluorescence density distribution I_{fl}(x)) is expressed by the following equation (24) when the convolution theorem is applied to equation (21).

$$\begin{matrix}I ( ξ ) = F [ f ( x ) ] & ( 22 F ) \\ I ( ξ ) = OTF ( ξ ) {I}_{R} ( ξ ) & ( 23 ) \\ {I}_{0} ( ξ ) = \int \int d ξ {I}_{0} ( ξ - ξ ) K ( ξ ) & ( 24 )\end{matrix}$$

To explain this qualitatively, the proportionality coefficient and the like will be ignored below. The intensity distribution K(x) of structured illumination IF of phase φ formed by two-light flux interference by light pulses LB (wavelength taken as λ) as illustrated in FIG. 1A is expressed by the following equation (25), and when the Fourier transform of this equation is taken, it results in equation (26). Therefore, equation (27) is obtained from equations (23), (24).

$$\begin{matrix} K ( x ) = 1 + cos ( \frac{2 π}{λ} {ξ}_{0} x - φ ) & ( 25 ) \\ \overline{K} ( ξ ) = δ ( ξ ) + \frac{δ ( ξ - {ξ}_{0 } ) \text{?} + δ ( ξ + {ξ}_{0} ) {e}^{iφ}}{2} & ( 26 ) \\ \overline{I} ( ξ ) = OTF ( ξ ) ( \frac{1}{2} {e}^{- iφ} \text{?} ( ξ - {ξ}_{0} ) + \text{?} ( ξ ) + \frac{1}{2} {e}^{iφ} \text{?} ( ξ + {ξ}_{0} ) ) & ( 27 ) \\ {\overline{I}}_{0} ( ξ ) … ( 28 Λ ) , {\overline{I}}_{0} ( ξ - {ξ}_{0} ) … ( 28 B ) , {\overline{I}}_{0} ( ξ + {ξ}_{0} ) … \\ \text{?} \text{indicates text missing or illegible when filed} & ( 28 C )\end{matrix}$$

The Fourier transform of image I(x) represented by equation (27) is obtained by taking the fluorescent image excited by the structured illumination IF via the imaging element 38, and then taking the Fourier transform of that image. Here, the unknowns are the three functions (equations (28A) to (28C)) on the right side of equation (27). Therefore, as illustrated in FIG. 5A, for example, light pulses LB at time points t₁, t₂, t₃ are irradiated on the AOM 18, and the imaging element 38 takes images of different phases obtained by varying (fringe scanning) the phase φ of the structured illumination IF in equation (25) to φ₁, φ₂, φ₃ (step 112). Then, in the calculating apparatus 44, the following calculations are performed on the obtained plurality of images, and a super-resolution image of the specimen 12 is reconstructed (step 114). That is, by taking the Fourier transform of the plurality of images of the specimen 12 obtained first, a Fourier transform image expressed by the following equations (29), (30), (31) and FIG. 24B is obtained. Where, the image when the phase shift quantity in equation (25) is taken as φ is denoted as I_{φ}.

$$\begin{matrix} \text{?} = OTF ( ξ ) ( \frac{1}{2} \text{?} ( ξ - {ξ}_{0} ) + {\overline{I}}_{0} ( ξ ) + \frac{1}{2} \text{?} ( ξ + {ξ}_{0} ) ) & ( 29 ) \\ \text{?} = OTF ( ξ ) ( \frac{1}{2} \text{?} ( ξ - {ξ}_{0} ) + {\overline{I}}_{0} ( ξ ) + \frac{1}{2} \text{?} ( ξ + {ξ}_{0} ) ) & ( 30 ) \\ \text{?} = OTF ( ξ ) ( \frac{1}{2} \text{?} ( ξ - {ξ}_{0} ) + {\overline{I}}_{0} ( ξ ) + \frac{1}{2} \text{?} ( ξ + {ξ}_{0} ) ) & ( 31 ) \\ [ \begin{matrix}\text{?} \\ \text{?} \\ \text{?}\end{matrix} ] = \frac{OTF ( ξ )}{2} [ \begin{matrix}\text{?} & \text{?} & \text{?} \\ \text{?} & \text{?} & \text{?} \\ \text{?} & \text{?} & \text{?}\end{matrix} ] [ \begin{matrix}\text{?} \\ \text{?} \\ \text{?}\end{matrix} ] \\ \text{?} \text{indicates text missing or illegible when filed} & ( 32 )\end{matrix}$$

When equations (29), (30), (31) are rewritten in determinant form, the above equation (32) is obtained. Here, in the calculating apparatus 44, equation (32) is solved and the Fourier transform images of equations (28A) to (28C) are determined, and image reconstruction is performed using these images. To do so, the three Fourier transform images calculated from equation (32) are superimposed on spatial frequency coordinates as illustrated in FIG. 24C. At this time, they are superimposed such that the spatial frequency components of the structured illumination remaining in equations (28B), (28C) come to the origin of the Fourier transform image of equation (28A). As a result, the optical transfer function (OTF) is magnified up to substantially twice the OTF of the image-forming optical system 36. In the calculating apparatus 44, a super-resolution image of the specimen 12 can be acquired by taking the inverse Fourier transform of those superimposed Fourier transform images. This image is displayed on, for example, the display apparatus 46.

Up to now, a method for realizing super-resolution in only one specified direction has been described. To obtain a two-dimensional super-resolution image, the above operations may be repeated by generating traveling waves in different directions (phase-type diffraction grating) using, for example, the AOM 18A in FIG. 7. Then, ultimately, Fourier transform images of different directions are composed on spatial frequency coordinates, and by taking the inverse Fourier transform thereof, a two-dimensional super-resolution image can be acquired.

As described above, the microscope 8 of this embodiment has the illumination apparatus 10 which illuminates the specimen plane 12a (specimen 12) as a plane to be observed. The illumination apparatus 10 has the AOM 18 which is disposed in a coherent light pulse LB constituted by laser light emitted from the light source system 14 and which forms the sonic traveling wave 19 in a direction traversing the emitted light pulse LB, and the condensing optical system 20 (illumination optical system) which forms, on the specimen plane 12a, structured illumination IF constituted by phase-variable interference fringes caused by a plurality of diffracted light beams LB1, LB2 (or LB0, LB1, LB2) generated from the AOM 18.

Furthermore, the illumination method by the illumination apparatus 10 is a method for illuminating the specimen plane 12a, wherein coherent light pulse LB constituted by a laser light beam is emitted from the light source system 14 (step 104), and structured illumination IF constituted by interference fringes is formed on the specimen plane 12a (steps 102, 108), the interference fringes having a phase that can be varied by a plurality of diffracted light beams LB1, LB2 (or LB0, LB1, LB2) generated from the AOM 18 which is disposed in the coherent light pulse LB and which forms the sonic traveling wave 19 in the direction traversing the emitted light pulse LB.

According to this illumination apparatus 10 or illumination method, because the interference fringes formed using the sonic traveling wave can be used as structured illumination, the phase of the structured illumination can be switched at high speed and with high precision during the structured illumination.

Also, the microscope 8 has the illumination apparatus 10 for illuminating the specimen plane 12a (plane to be observed), the image-forming optical system 36 for forming an image by fluorescence LF generated from the specimen plane 12a, the imaging element 38 for detecting that image, and the calculating apparatus 44 for processing information on a plurality of images detected by the imaging element 38 and determining, for example, an image having a structure exceeding the resolution of the image-forming optical system 36.

In the observation method by the microscope 8, the specimen plane 12a is illuminated by the illumination method (steps 102 to 108), and images are formed via the image-forming optical system 36 from fluorescence LF generated from the specimen plane 12a and the images are then detected (steps 110, 112), and the information on the plurality of detected images is processed, and, for example, an image having a structure exceeding the resolution of the image-forming optical system 36 is determined (step 114).

According to this microscope 8 or observation method, the phase of the structured illumination IF can be varied at high speed and with high precision on the specimen plane 12a by the illumination apparatus 10 or the illumination method thereof, and as a result, a super-resolution image of the specimen 12 can be determined at high speed and with high precision using images of the specimen plane 12a.

Furthermore, in this embodiment, the repetition frequency fᵣₑₚ of the light pulse LB may be set to 1/N (N is an integer of 1 or greater) times the frequency f_{AOM}, and the timing with which the light pulse LB is incident on the AOM 18 may be relatively controlled by the control apparatus 40 (timing control unit). The phase of the structured illumination IF on the specimen plane 12a can be varied at high speed and with high precision by this configuration as well.

### Second Embodiment

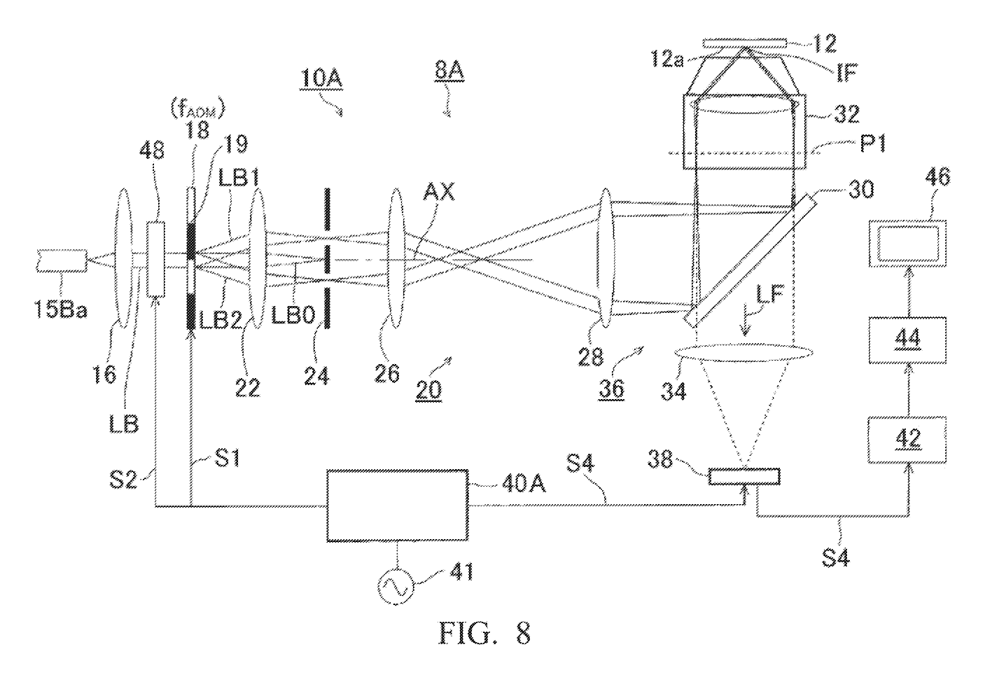

A second embodiment of the present invention will be described in reference to FIGS. 8 to 11D.

In the above first embodiment, high-speed variation of the phase of the structured illumination IF is realized by detecting individual light pulses LB. However, depending on the case, there is a risk that phase switching will be too fast and the frame rate of an ordinary imaging element will not be able to keep up therewith. Furthermore, when an image is obtained from only one light pulse LB, there is a risk that the SN ratio will decrease because the light quantity per image is small. In this embodiment, even in such a case, by integrating a plurality of pulsed light beams, the phase switching of fringes generated on a specimen plane by structured illumination is matched to the frame rate of an ordinary imaging element, and a sufficient increase in speed can be achieved and the SN ratio can be improved.

FIG. 8 illustrates a schematic configuration of a microscope 8A having an illumination apparatus 10A pertaining to this embodiment. Note that in FIG. 8, the same reference numerals are assigned to parts that correspond to those in FIG. 1A, and detailed descriptions of the parts are omitted. In FIG. 8, the illumination apparatus 10A has a lens 16 for collimating the light pulse LB emitted from an end portion 15Ba of an optical fiber, an AOM (acousto-optic modulator) 48 for switching the light pulse LB, which is disposed between the lens 16 and an AOM 18 on which the light pulse LB is incident, and a control apparatus 40A for driving the AOM 18 and the AOM 48 by driving signals S1 and S2, respectively. Any other configuration is the same as the first embodiment.

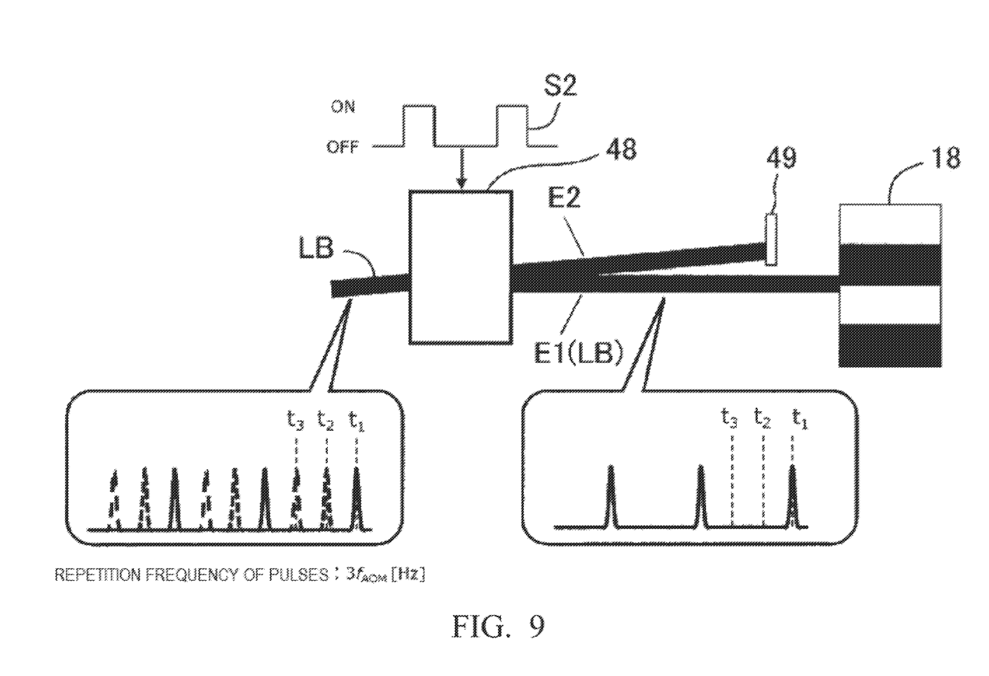

Here, description will be given of an example of two-light flux mode in which structured illumination IF is generated on the specimen plane 12a using ±first-order light beams generated by the AOM 18 from the light pulse LB. In this case, when the frequency of a traveling wave 19 in the AOM 18 is taken as f_{AOM}, the frequency fᵣₑₚ of the light pulse LB is 3f_{AOM}. The AOM 48 has the role of selecting only pulsed light beams of a certain specified time interval among the incident light pulses LB. The AOM 48 is modulated by an electrical signal of frequency f_{AOM}, and, among the diffracted light beams generated from the AOM 48, only the first-order light beam is guided along an optical path El to the AOM 18 as illustrated in FIG. 9, and the other diffracted light beam (zero-order light beam in FIG. 9) is guided along an optical path E2 to a shielding part 49. When the driving signal S2 is on, the first-order diffracted light beam is generated, but when off, the first-order diffracted light beam is not generated. As a result, only a light pulse of a certain time interval (T=1/f_{AOM}) can be selected, and the repetition frequency of the light pulse LB, which is 3f_{AOM} when incident on the AOM 48, is changed to f_{AOM}, thereby allowing the light pulse to turn into incident light on the AOM 18. In the example of FIG. 9, in the period when the driving signal S2 is on (high level), the first-order diffracted light beam is selected and guided as the light pulse LB to the AOM 18.

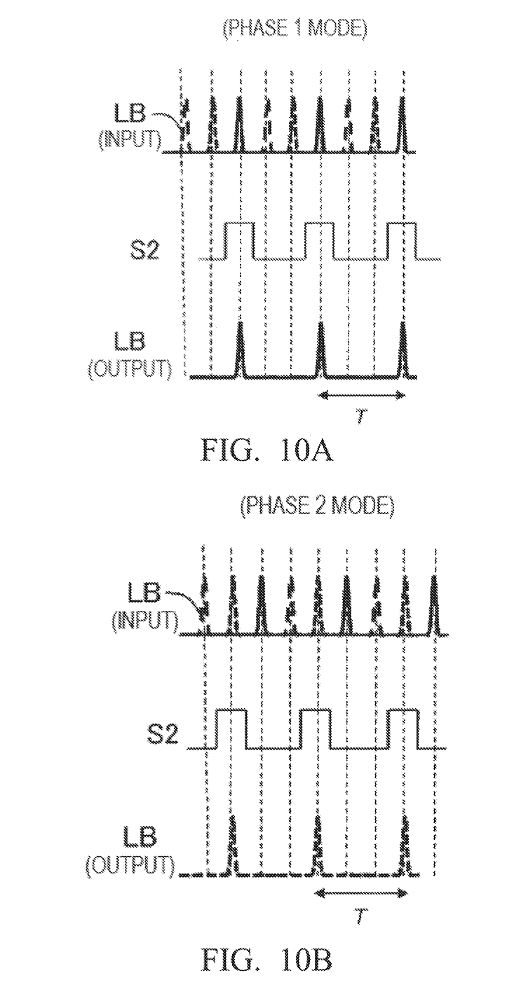

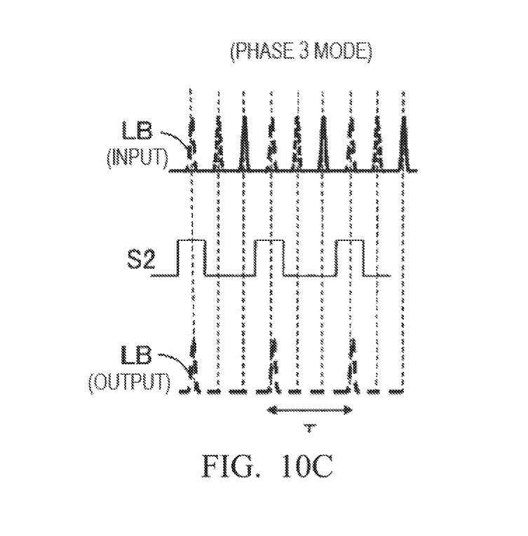

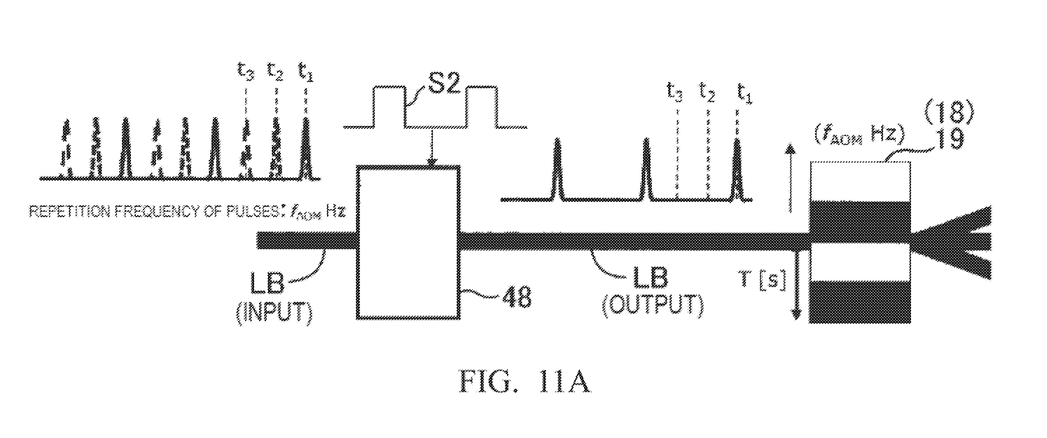

The principle of this switching is illustrated in FIGS. 10A to 10C. A periodic binary signal of frequency f_{AOM} is used as the driving signal S2 applied to the AOM 48. The duty ratio of this binary signal (ratio of on period within one period) is set to 1/3. This signal is preferably a rectangular wave. As illustrated in FIGS. 10A, 10B, 10C, by varying the phase of the binary signal (driving signal S2) to 0° (for example, the same phase as the driving signal S1 when one period is taken as 360°), 120°, 240°, the desired light pulse LB can be selected from the light pulses LB input to the AOM 48 and can be output with period T (same period as the traveling wave 19 in the AOM 18). By this switching, a series of light pulses LB of different phases, in which the frequency fᵣₑₚ′ when incident on the AOM 18 is f_{AOM}, can be generated. For convenience of explanation, the conditions of selecting a light pulse LB in the above three different phases (for example, 0°, 120°, 240°) are called phase 1 mode, phase 2 mode, and phase 3 mode, respectively. Phase 1 mode, phase 2 mode, and phase 3 mode are also conditions of selecting and outputting light pulses LB generated at time points t₁, t₂, t₃ in FIG. 9, respectively.

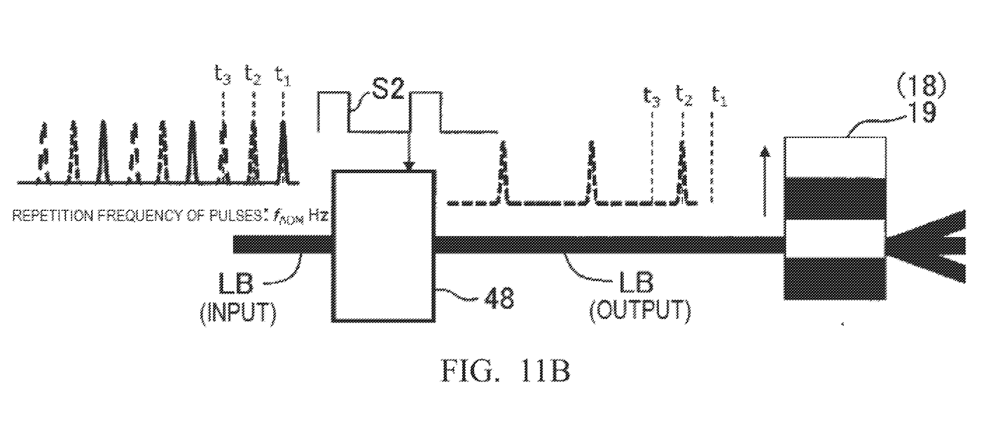

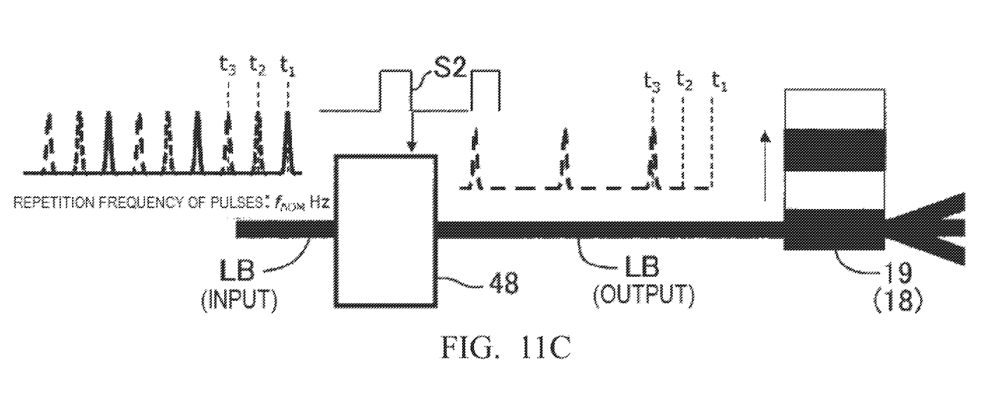

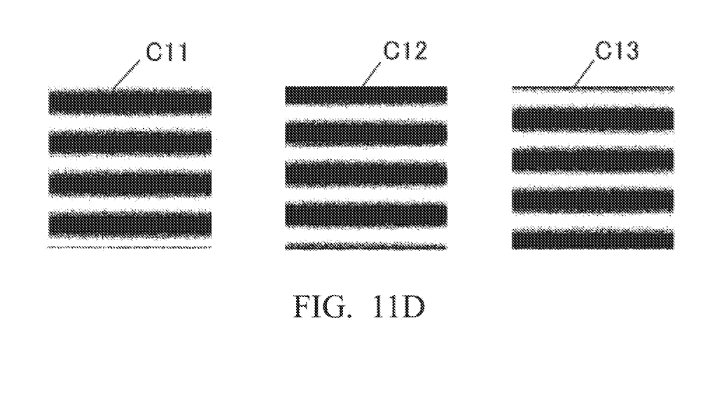

As illustrated in FIGS. 11A, 11B, 11C, because the repetition frequency fᵣₑₚ′ when the light pulses LB selected by the AOM 48 in phase 1 mode, phase 2 mode, and phase 3 mode are output matches the frequency f_{AOM} of the AOM 18, the diffraction grating generated in the AOM 18 appears to be still with respect to the light pulses LB. Therefore, in each of the phase modes, even when the structured illumination IF constituted by diffracted light beams from the light pulses LB on the specimen plane 12a is integrated, it results in integration of structured illumination of the same phase. In this way, the patterns of structured illumination generated on the specimen plane 12a by the light pulses LB of phase 1 mode, phase 2 mode, and phase 3 mode are the same in the modes, as illustrated in patterns C11, C12, C13 of FIG. 11D, and therefore, it is possible to integrate the fluorescent images obtained by the structured illumination IF on the imaging element 38.

Here, the image-obtaining time by the imaging element 38 is estimated. As a result, when integrating 1000 images for every light pulse LB at a frequency f_{AOM} of 10 MHz, the image-acquisition time required to construct one super-resolution image is 100 μs.

In this way, integration of pulsed light beams is allowed; thus, an imaging element 38 having an ordinary frame rate can be used, and the SN ratio can be improved. After a fringe image of a certain phase is acquired by pulse integration, an image of another phase is acquired by switching being performed by the AOM 48. By repeating this for the required number of images, a plurality of images required by the microscope 8A that uses structured illumination can be acquired at high speed.

In this embodiment, the control apparatus 40A in FIG. 8 receives an AC signal of frequency f_{AOM} from a signal generator 41, and drives the AOM 18 using the AC signal. Additionally, the control apparatus 40A receives a rectangular AC signal of frequency f_{AOM} from the signal generator 41, and drives the AOM 48 using the rectangular AC signal. Furthermore, the control apparatus 40A modulates the phases of the driving signals to realize the switching described above, and generates, from the driving signals, a control signal S4 containing a trigger signal of the imaging element 38. In this case, it is preferable that the signals are controlled so as to be consistently synchronized.

Furthermore, in this embodiment as well, the pitch of the diffraction grating generated by the AOM 18 can be varied by varying the oscillation frequency of the signal transmitter 41, similar to the first embodiment. The same is true for the third to seventh embodiments described below.

Also, it is preferable that the AOM 18A that can generate a traveling wave in three directions in FIG. 7 be used so as to set the orientation of the structured illumination to a plurality of orientations (for example, three orientations) at high speed rather than using a mechanical driving mechanism. Furthermore, similar to the first embodiment, the AOM 18 may be mechanically rotated instead of using the AOM 18A. The same is true for the third to seventh embodiments described below.

Note that two-light flux mode has been described as an example here, but this embodiment may also be applied in three-light flux mode. In that case, because the fringe phase of the structured illumination needs to be varied to five phases, the repetition frequency fᵣₑₚ of light pulses LB emitted from the coherent light source may be set to 5f_{AOM}, and light pulses LB may be selected by applying a driving signal of frequency f_{AOM} having a duty ratio of 1/5 to the AOM 48 for switching. Furthermore, the AOM 48 is used as the switching element in this embodiment, but this embodiment may also be applied in a case where a rotating shutter like a chopper is used. In that case, it is preferable to control the rotational frequency and phase of the chopper using the control apparatus 40A.

### Third Embodiment

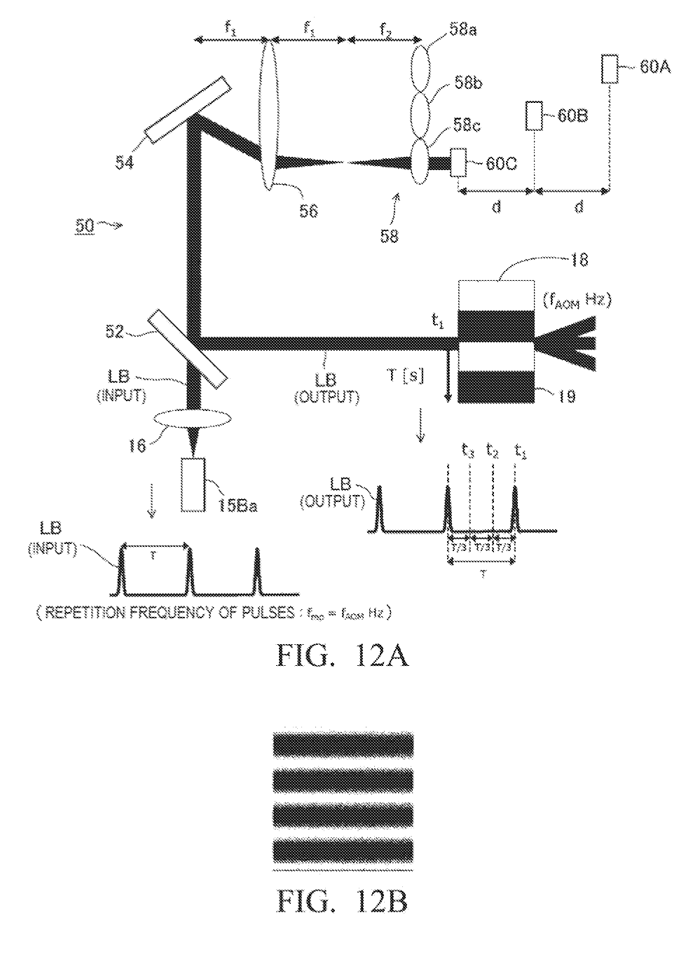

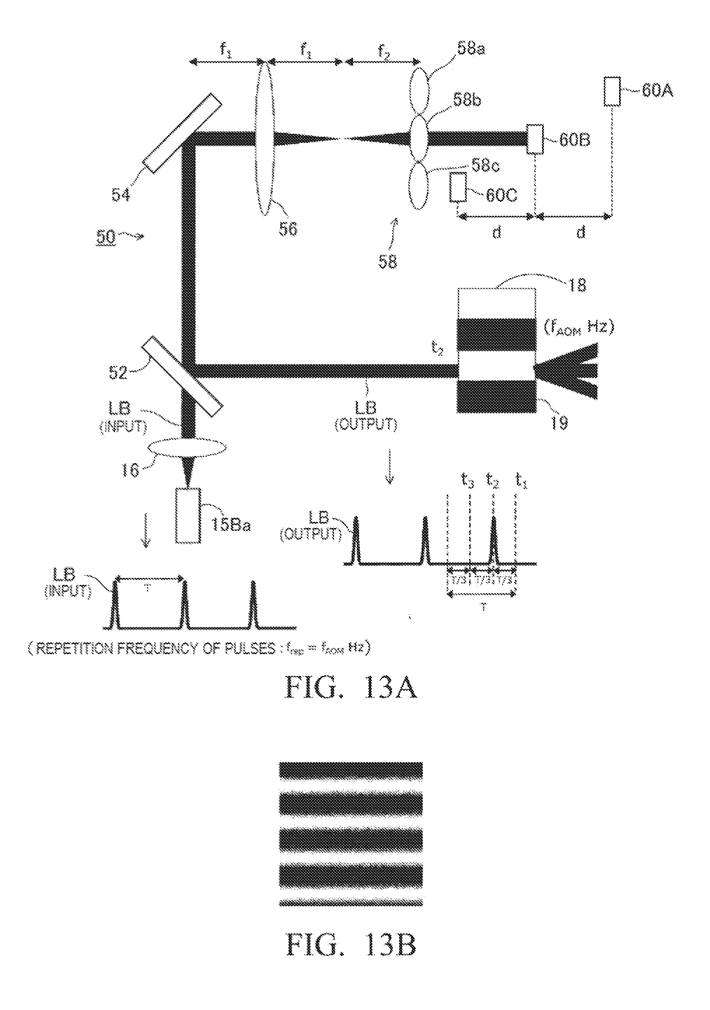

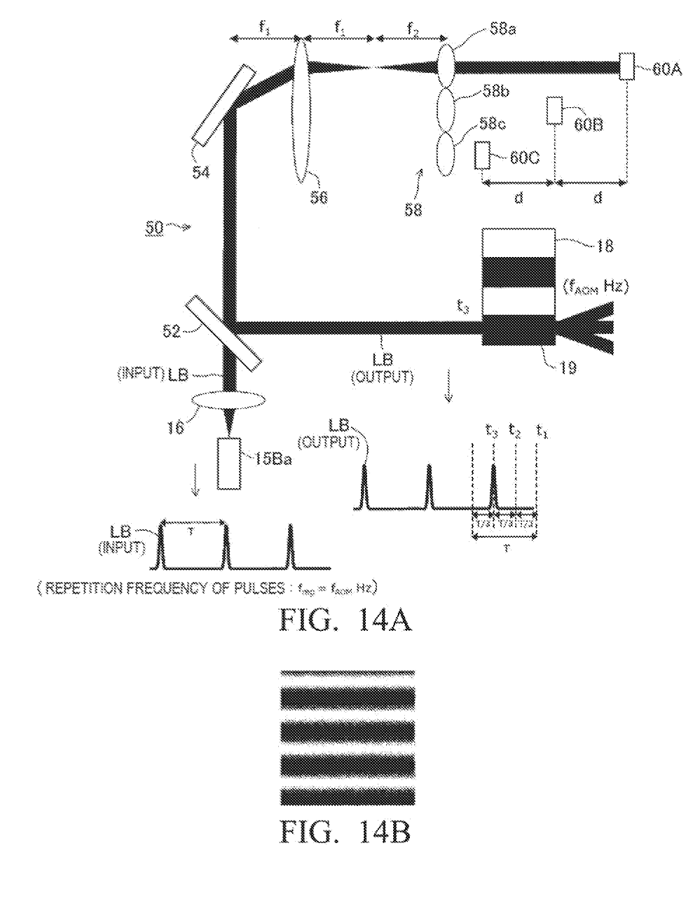

A third embodiment will be described in reference to FIGS. 12A to 14B. In this third embodiment, phase switching of the structured illumination on the specimen plane is accelerated with a simple and inexpensive configuration. In the second embodiment, switching of the light pulse LB is performed using the AOM 48, and integration of an image of each pulsed light beam is realized. In contrast, in this embodiment, the frequency f_{AOM} of the sonic wave of the AOM 18 and the repetition frequency fᵣₑₚ of the light pulse LB are made equal to each other, and phase switching of the structured illumination is performed by switching the optical path of the light pulse LB using a galvanometer mirror (oscillating mirror). To do so, the phase difference of the light pulse LB is varied using the difference in optical path length, and the temporal timing of the phase-type diffraction grating in the AOM 18 and the light pulse LB is controlled.

FIGS. 12A, 13A, 14A each illustrate essential parts of the illumination apparatus of the microscope of this embodiment (essential parts of light source system 50 and AOM 18). In FIGS. 12A to 14A, the same reference numerals are assigned to parts that correspond to those in FIG. 1A, and the optical system beyond the AOM 18, the calculating apparatus, and the like which are the same as those in the first embodiment are omitted. Here, two-light flux mode will be described as an example. In two-light flux mode, interference fringes of three phases need to be generated as structured illumination formed on the specimen plane by two diffracted light beams generated from the AOM 18.

In the light source system 50 of the illumination apparatus in FIG. 12A, a light pulse LB emitted from an end portion 15Ba of an optical fiber is collimated by a lens 16, and is incident as input pulsed light on a half mirror 52. A light beam that passes through the half mirror 52 is reflected by a galvanometer mirror 54. The light beam reflected by the galvanometer mirror 54 is condensed by a lens 56 at the focal position of the lens 56 (focal length is taken as f₁). Here, because the galvanometer mirror 54 is disposed at the front-side focal position of the lens 56, the galvanometer mirror 54 and lens 56 constitute a telecentric optical system. Therefore, the principal ray of the light beam condensed by the lens 56 is parallel to the optical axis of the lens 56.

The light beam condensed by the lens 56 is incident on a lens group 58 constituted by three lenses 58a, 58b, 58c (each focal length is taken as f₂). Because the front-side focal position of the lens group 58 coincides with the focal position of the lens 56, the light beam from the lens 56 is collimated by the lens group 58, and the collimated light beam is reflected by any of the mirrors 60A, 60B, 60C, and is again incident on the lens group 58. The light beam returned to the lens group 58 is condensed at the rear-side focal position of the lens 56, collimated by the lens 56, and again reflected by the galvanometer mirror 54. The light beam reflected again by the galvanometer mirror 54 is then reflected by the half mirror 52 and guided to the AOM 18 as an output light pulse LB.

Here, the method for phase switching using the galvanometer mirror 54 will be described. The angle of the galvanometer mirror 54 is varied in order to select a lens in the lens group 58 (lenses 58a, 58b, 58c) to which a light beam reflected by the galvanometer mirror 54 is guided. A light beam collimated by the respective lenses in the lens group 58 is reflected by the mirrors 60A to 60C and is again incident on the lens group 58, but the mirrors 60A to 60C are disposed such that the distances between the mirrors 60A, 60B, 60C and their corresponding lenses 58a, 58b, 58c differ from each other by d. When the repetition frequency of the light pulse LB is taken as fᵣₑₚ (here, equal to f_{AOM}), required phase variable number is taken as m, and the speed of a light beam is taken as c, the spacing d between the mirrors is given as follows:

d=c/(2mfᵣₑₚ) (5)

This means that the spacing d is set such that the time required for a light beam to travel a distance of 2d (round-trip distance) is 1/m times the time period T(=1/fᵣₑₚ) of the diffraction grating in the AOM 18. FIGS. 12A, 13A, and 14A illustrate states in which the angle of the galvanometer mirror 54 is controlled such that the light beam from the galvanometer mirror 54 is guided to the lens 58c, lens 58b, and lens 58a, respectively. In FIGS. 12A, 13A, and 14A, the phase of the light pulse LB incident on the AOM 18 also varies because the optical path lengths of light beams returning to the half mirror 52 via the lens group 58 and the galvanometer mirror 54 differ from each other. By setting the spacing d according to equation (5), the phase relationship between the light pulse LB and the traveling wave 19 (diffraction grating) in the AOM 18 can be sequentially shifted by one-third of a period, like the respective light pulses LB generated at time points t₁, t₂, and t₃ in FIGS. 12A, 13A, and 14A.

Here, because the repetition frequency fᵣₑₚ of the light pulses LB is equal to the frequency f_{AOM} of the sonic wave of the AOM 18, the AOM 18 appears to be still with respect to these light pulses LB. For this reason, it is possible to integrate structured illumination generated by a plurality of light pulses LB. The structured illumination generated on the specimen plane by the light pulses LB of FIGS. 12A, 13A, and 14A is illustrated in FIGS. 12B, 13B, and 14B. Thus, according to this embodiment, phase variation of structured illumination can be realized by varying the phase of the light pulse LB using the galvanometer mirror 54. Furthermore, the repetition frequency of the light pulse may satisfy fᵣₑₚ=f_{AOM}/N, provided that N is an integer of 1 or greater. By increasing the integer N, an image acquired using structured illumination microscopy (hereinafter, called “SIM image”) can be acquired at the maximum frame rate in accordance with various cameras.

In the microscope of this embodiment, when structured illumination of a certain phase is projected on a specimen and an image is taken, images are acquired by integrating the required number of pulsed light beams. When the phase of the structured illumination is varied, the phase of the pulsed light beam may be varied by varying the angle of the galvanometer mirror 54 to select a different lens of the lenses 58a to 58c. As a result, the timing between the pulsed light beam and the diffraction grating in the AOM 18 can be varied, and in that state, images can be acquired again by integrating the pulsed light beams.

Furthermore, since current ordinary galvanometer mirrors can operate at approximately 10 kHz, phase switching can be performed at this frequency.

Note that the description has been made for two-light flux mode as an example, but this embodiment may also be applied in three-light flux mode. In that case, because the mask needs to be changed so as to pass the zero-order light beam therethrough, and the fringe phase of the structured illumination needs to be varied to five phases, the lens group 58 needs to be constituted by five lenses, and mirrors corresponding to the lenses need to be disposed at appropriate positions determined by equation (5).

### Fourth Embodiment

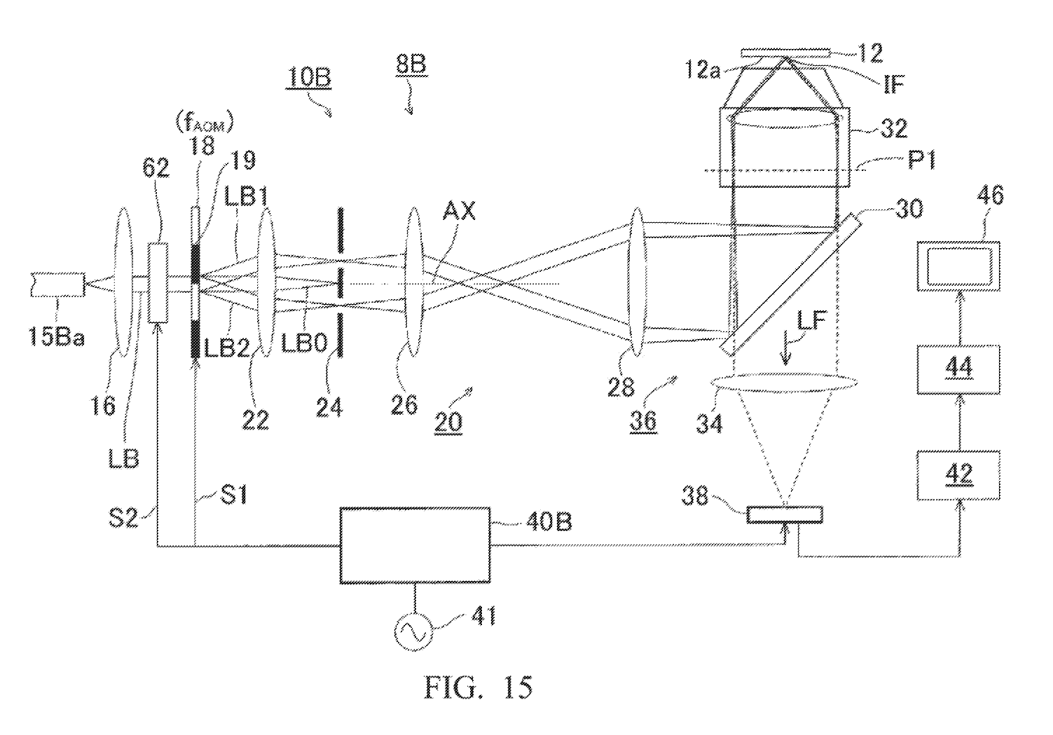

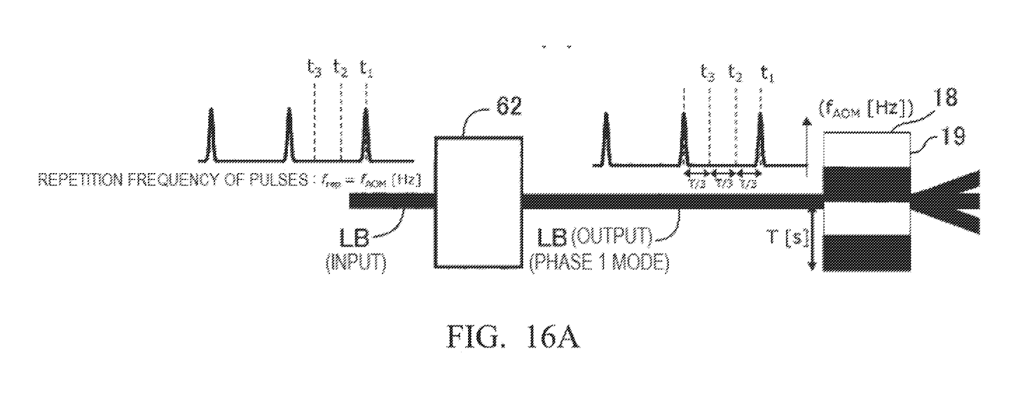

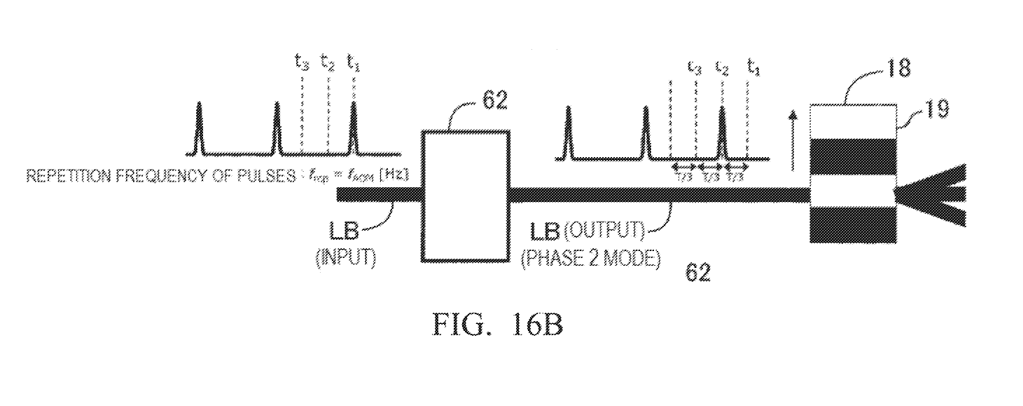

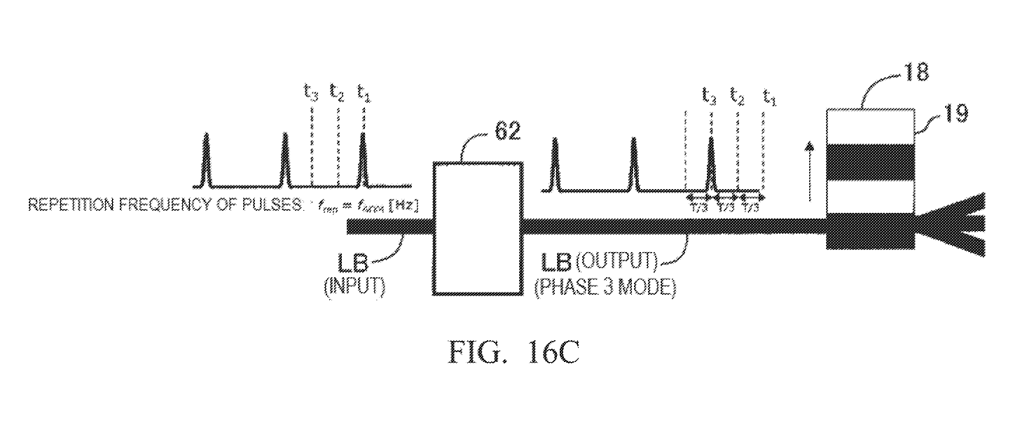

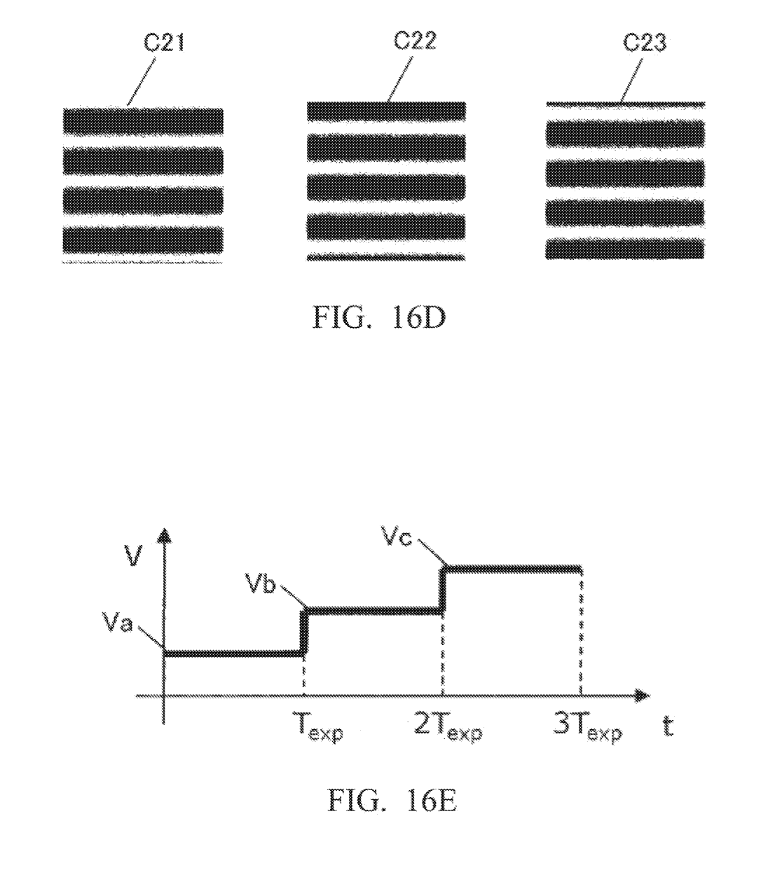

A fourth embodiment will be described in reference to FIGS. 15 to 16D. In this embodiment, the frequency f_{AOM} of the AOM 18 and the repetition frequency fᵣₑₚ of the pulsed light beam are made equal to each other, and the phase of the pulsed light beam is varied using an electro-optic element or electro-optic modulator (EOM), thereby varying the relative phase between the pulsed light beam and the AOM 18 so as to allow integration of the pulsed light beam.

FIG. 15 illustrates a schematic configuration of a microscope 8B having an illumination apparatus 10B and a control apparatus 40B pertaining to this embodiment. Note that in FIG. 15, the same reference numerals are assigned to parts that correspond to those in FIG. 1A, and detailed descriptions thereof are omitted. In FIG. 15, an electro-optic modulator (hereinafter, referred to as “EOM”) 62 is disposed between a lens 16 for collimating a light pulse LB emitted from an end portion 15Ba of an optical fiber and an AOM 18 on which the collimated light pulse LB is incident. The EOM 62 is constituted by a substrate, such as lithium niobate or KTP, having an electrode for voltage application provided thereon. A control apparatus 40B controls the AOM 18 and the EOM 62 via driving signals S1 and S2, respectively. Any other configuration is the same as the first embodiment.

Phase modulation in this embodiment is illustrated in FIGS. 16A to 16C. Here, two-light flux mode will be described as an example. In two-light flux mode, interference fringes of three phases need to be generated as structured illumination IF formed on a specimen plane 12a using two diffracted light beams generated from the AOM 18.

The EOM 62 is an optical device that utilizes an electro-optic effect. The refractive index of the optical path varies according to an applied voltage; thus, the EOM 62 can modulate the phase of an incident light beam. As illustrated in FIGS. 16A to 16C, a light pulse LB which is incident on (input to) the EOM 62 and has a period T is output (emitted) after the phase of light pulse LB is varied by the EOM 62, thereby allowing the phase relationship between the light pulse LB and the diffraction grating in the AOM 18 to be controlled, and realizing structured illumination having a desired fringe phase.

Assuming that a light pulse LB is incident at time point t₁, the phase modes of light pulses LB relative to the diffraction grating in the AOM 18 when the light pulses LB are emitted from the EOM 62 at time point t₁, time point t₂ which is delayed by T/3 from time point t₁, and time point t₃ which is delayed by T/3 from time point t₂, as illustrated in FIGS. 16A, 16B, 16C, are called phase 1 mode, phase 2 mode, and phase 3 mode, respectively. Comparing the light pulses LB of phase 1 mode, phase 2 mode, and phase 3 mode, the light pulses have a T/3 time delay sequentially. Such a phase delay can be provided by controlling the voltage applied to the EOM 62. To do so, a voltage as illustrated in FIG. 16E is applied to the EOM 62. Voltages Va, Vb, Vc in FIG. 16E correspond to the voltages applied to the EOM 62 in FIGS. 16A, 16B, 16C. Because the refractive index of the EOM varies according to an applied voltage, the voltage needs to be controlled so as to provide an appropriate refractive index. Time Tₑₓₚ for which a constant voltage is applied is determined by the number of required pulses to be integrated, and is equivalent to the integration time of a camera (imaging element).

The time delay provided by the EOM 62 is equivalent to the phase delay of the light pulse LB. Therefore, because the phase of the diffraction grating in the AOM 18 differs for the light pulse LB of each phase mode, the specimen plane can be excited by structured illumination of mutually different phases in the three phase modes, as illustrated in patterns of structured illumination C21, C22, C23 in FIG. 16D, which correspond to phase 1 mode, phase 2 mode, and phase 3 mode.

Also, because the repetition frequency fᵣₑₚ of the light pulses LB is equal to the frequency f_{AOM} of the sonic wave of the AOM 18, the AOM 18 appears to be still with respect to the light pulses LB. For this reason, a plurality of light pulses can be integrated. In this way, integration of light pulses is allowed; thus, an imaging element 38 having an ordinary frame rate can be used, and the SN ratio can be improved. Furthermore, the repetition frequency of the light pulse may satisfy fᵣₑₚ=f_{AOM}/N, provided that N is an integer of 1 or greater. By increasing N, SIM images can be acquired at the maximum frame rate in accordance with various cameras.

In this embodiment, an image (fringe image) of the specimen excited by structured illumination of a certain phase is acquired, and then an image of a different phase is acquired by varying the phase of the light pulse using the EOM 62. By repeating this process for the required number of images, a plurality of images required by the microscope that uses structured illumination can be acquired at high speed.

Note that two-light flux mode has been described as an example here, but this embodiment may also be applied in three-light flux mode. In that case, because a mask 24 needs to be changed so as to pass the zero-order light beam therethrough and the fringe phase of the structured illumination needs to be varied to five phases, the EOM 62 may be driven so as to vary the phase of the light pulse by T/5 at a time.

### Fifth Embodiment

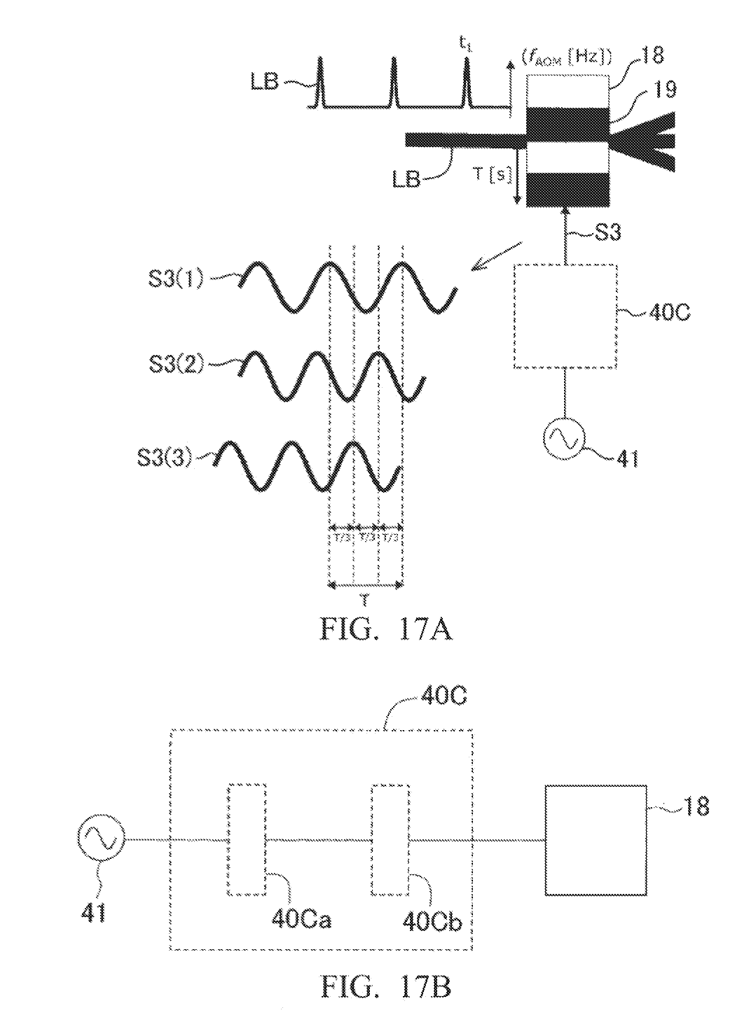

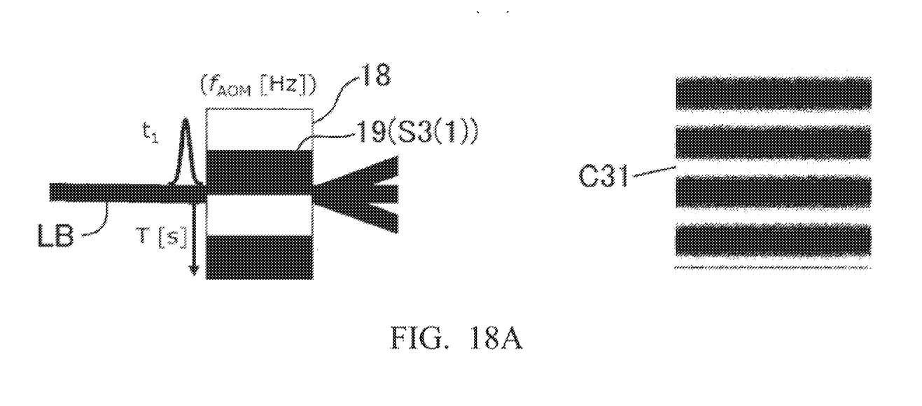

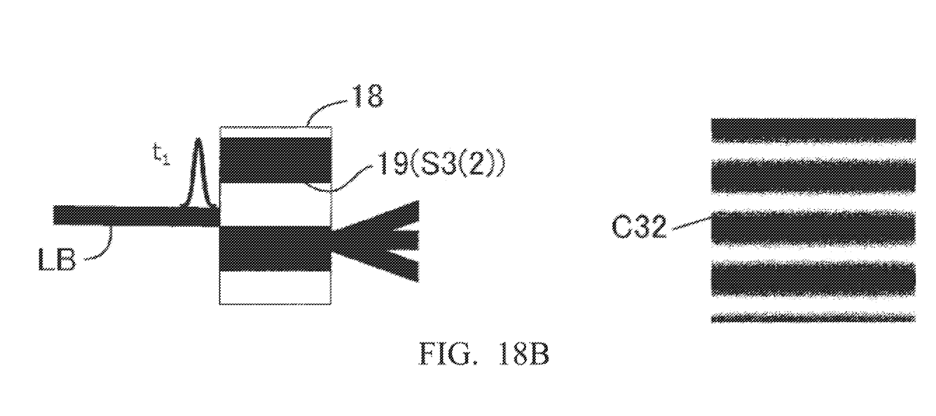

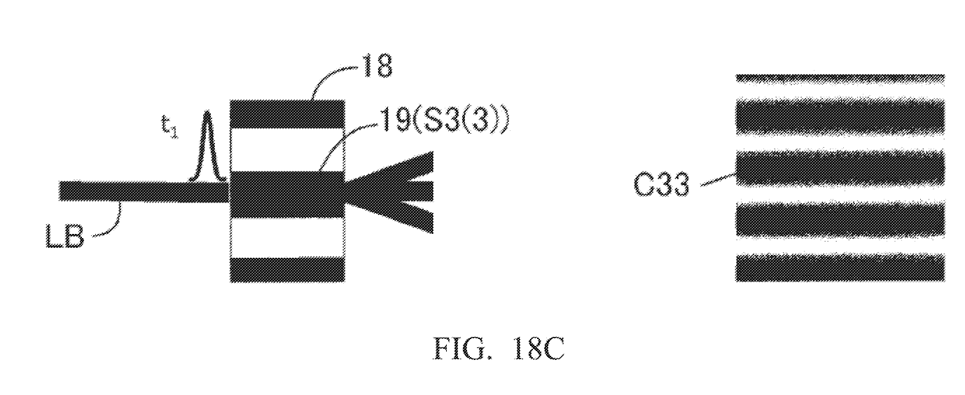

A fifth embodiment will be described in reference to FIGS. 17A to 18C. In this embodiment, the frequency f_{AOM} of the AOM 18 and the repetition frequency fᵣₑₚ of the light pulse LB are made equal to each other, and the phase of an AC signal (having the frequency f_{AOM}) that drives the AOM 18 is varied, thereby varying the phase of the light pulse. Accordingly, it is possible to vary the relative phase between the light pulse and the AOM 18 and to integrate the light pulses.

FIG. 17A illustrates the AOM 18 and a control apparatus 40C of the illumination apparatus of the microscope of this embodiment. FIG. 17B illustrates a configuration example of the control apparatus 40C. Any other configuration is the same as the first embodiment. Here, two-light flux mode will be described as an example. In two-light flux mode, interference fringes of three phases need to be generated as structured illumination formed on the specimen plane by two diffracted light beams generated from the AOM 18.

In FIG. 17A, a driving signal S3 constituted by an AC signal of frequency f_{AOM} is applied from the control apparatus 40C to the AOM 18. The AOM 18 functions as a diffraction grating depending on its frequency, according to equation (1). When the time period of the pitch of the diffraction grating is taken as T, the time period of the applied driving signal is also T. By varying the phase of this driving signal by T/3 at a time, as illustrated by signals S3(1), S3(2), S3(3) in FIG. 17A, the relative phase between the light pulse and the AOM 18 can be varied.

In order to vary the phase of the driving signal S3 in this manner, a phase adjusting circuit 40Ca is provided in the control apparatus 40C as illustrated in FIG. 17B. Furthermore, a switching circuit 40Cb is an orientation switch illustrated in FIG. 7. The phase of the driving signal S3 which has frequency f_{AOM} and is input to the AOM 18 with this control apparatus 40C can be shifted by T/3 at a time.

FIGS. 18A, 18B, 18C illustrate the timing between the light pulse LB and the diffraction grating in the AOM 18 when the respective driving signals S3(1), S3(2), S3(3) are supplied to the AOM 18. The respective light pulses LB are incident on the AOM 18 at the same time point t₁. However, because the phase of the diffracting grating in the AOM 18 varies by making the phase of the sonic wave applied to the AOM 18 variable, it is possible to vary the phase of the fringes of the structured illumination generated on the specimen plane by each of the light pulses, as illustrated by patterns C31, C32, C33 in FIGS. 18A, 18B, 18C.

Because the repetition frequency fᵣₑₚ of the light pulses LB is equal to the frequency f_{AOM} of the sonic wave of the AOM 18, the diffraction grating in the AOM 18 appears to be still with respect to the light pulses LB. Therefore, a plurality of light pulses can be integrated. After the required number of light pulses are integrated and images are acquired, the phase of the driving signal input to the AOM 18 is varied by T/3 using the phase adjusting circuit 40Ca in FIG. 17B, and, once again, the required number of light pulses are integrated and images are acquired. This operation may be repeated a number of times equal to the number of images required. Furthermore, the repetition frequency of the light pulse may satisfy fᵣₑₚ=f_{AOM}/N, provided that N is an integer of 1 or greater. By increasing N, a SIM image can be acquired at the maximum frame rate in accordance with various cameras. Note that two-light flux mode has been described as an example here, but this embodiment may also be applied in three-light flux mode. In that case, the mask needs to be changed so as to pass the zero-order light beam therethrough, and the fringe phase of the structured illumination needs to be varied to five phases, the phase of the driving signal applied to the AOM 18 may be varied by T/5 at a time.

### Sixth Embodiment

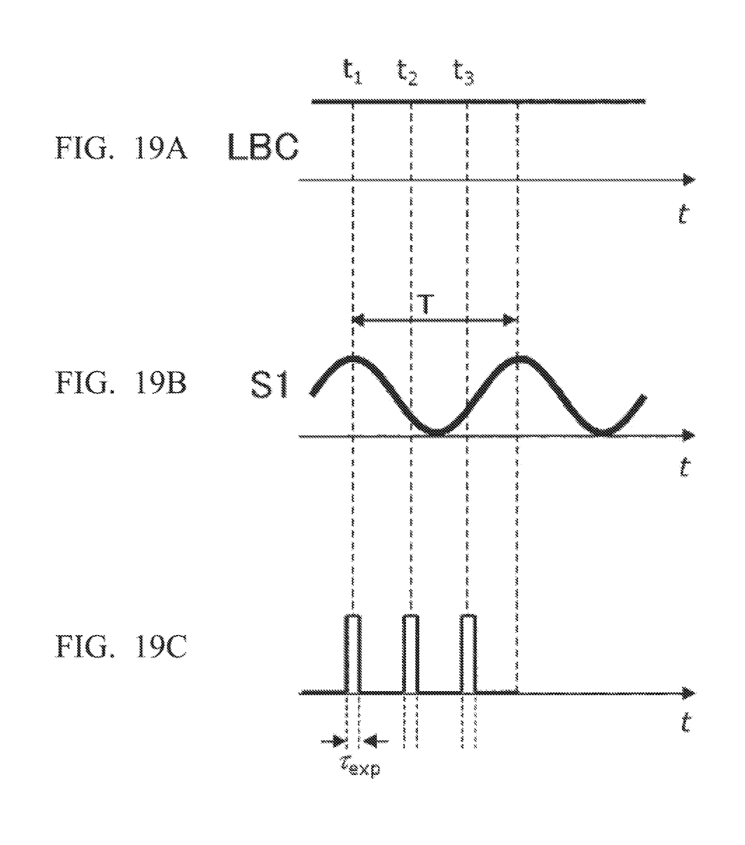

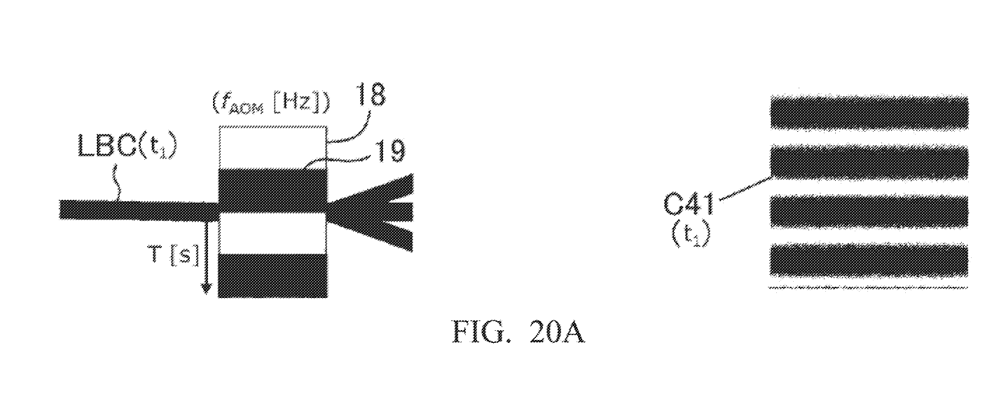

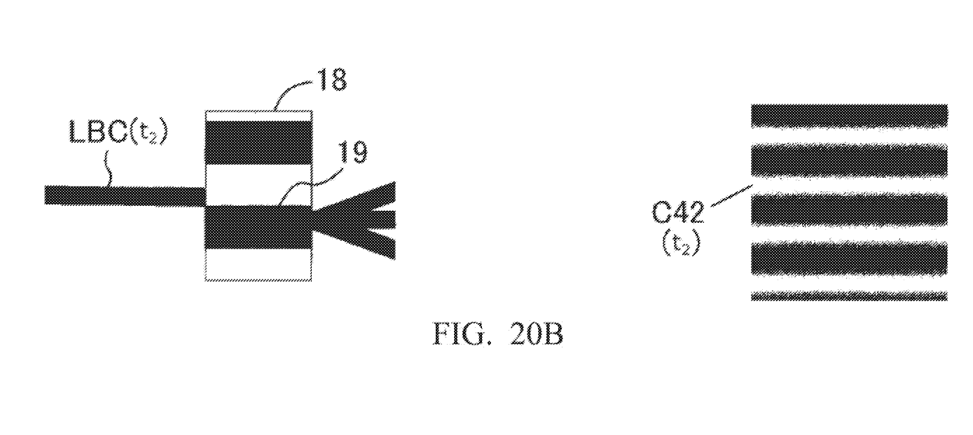

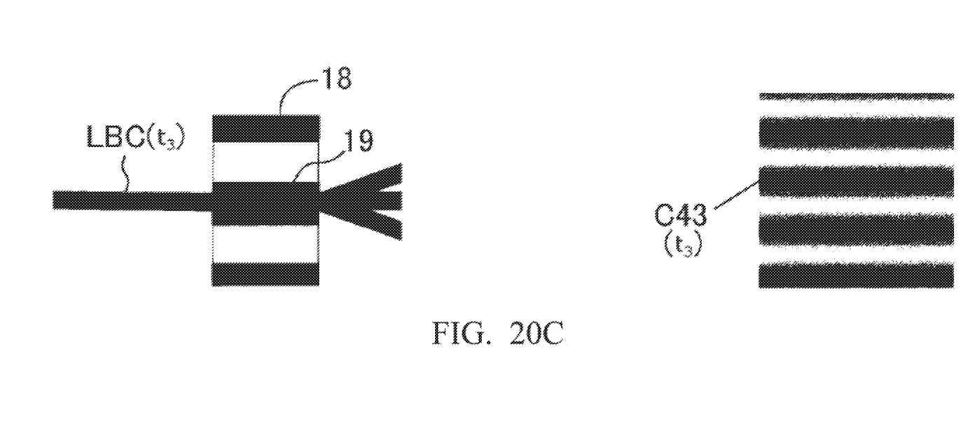

A sixth embodiment will be described in reference to FIGS. 19A to 20C. In this embodiment, a coherent light source 15AC constituted by a continuous-wave (CW) laser light source is used instead of the coherent light source 15A constituted by a pulse laser light source in FIG. 1A. A coherent laser light beam with temporally constant light intensity (hereinafter, referred to as “continuous light”) LBC is emitted from the coherent light source 15AC. As the CW laser light source, for example, an argon ion laser (having a wavelength of 488 nm), a helium neon laser, a helium cadmium laser, or the like may be used. The configuration of this embodiment is the same as that of the first embodiment except that the continuous light beam LBC is used as the coherent light beam. Here, two-light flux mode will be described as an example. In two-light flux mode, interference fringes of three phases need to be generated as structured illumination formed on the specimen plane by two diffracted light beams generated from the AOM 18.

Furthermore, in this embodiment, after synchronizing the frame rate of an imaging element 38 with the frequency of the sonic wave of the AOM 18, the exposure time of the imaging element 38 is set to a very short time to the extent that a traveling wave (phase-type diffraction grating) in the AOM 18 can be regarded as being still. Because the AOM 18 is of the traveling wave type, the phase of the structured illumination IF projected on a specimen plane 12a constantly varies at the frequency f_{AOM} of the sonic wave of the AOM 18. When the time period of that sonic wave (diffraction grating) is represented by T, it becomes T=1/f_{AOM}. The use of the continuous light beam LBC as the incident light beam causes the pattern of interference fringes projected on the specimen 12 to constantly move in the periodic direction of the interference fringes.

Making the exposure time τₑₓₚ of the imaging element 38 sufficiently shorter than the time period T of the diffraction grating in the AOM 18 allows the dynamic interference fringes to be still. This situation is illustrated in FIGS. 19A to 19C.

The continuous light beam LBC incident on the AOM 18 has a temporally constant light intensity (refer to FIG. 19A). A driving signal S1 constituted by an AC signal is applied to the AOM 18 from a signal oscillator 41 via a control apparatus 40. The frequency of the driving signal S1 is f_{AOM}, and the time period is T(=1/f_{AOM}) (refer to FIG. 19B). The interference fringes (structured illumination IF) formed on the specimen plane 12a move constantly, with the time period T as one period.

However, making the exposure time τₑₓₚ of the imaging element 38 sufficiently shorter than period T as illustrated in FIG. 19C allows moving interference fringes to appear to be still. Furthermore, in two-light flux mode, by setting the frame rate fᵣ of the imaging element 38 to 3f_{AOM} and acquiring three images with the exposure time τₑₓₚ during one fringe period T, it is possible to acquire, at high speed, a fluorescent image excited by structured illumination of different phases required in a microscope that uses structured illumination.

FIGS. 20A, 20B, 20C illustrate the relationship between the continuous light beam LBC and the phase-type diffraction grating (traveling wave 19) generated in the AOM 18 at time points t₁, t₂, t₃ shifted from each other by 1/3 period (T/3) in FIGS. 19A to 19C. Patterns C41, C42, C43 of FIGS. 20A, 20B, 20C are examples of a structured illumination pattern formed on the specimen plane 12a by a plurality of diffracted light beams generated by the AOM 18 from the continuous light beams LBC at time points t₁, t₂, t₃. In this embodiment as well, the specimen 12 can be excited by the desired structured illumination in this manner.

The speed of phase switching that can be reached in this embodiment will now be approximated. The speed of phase switching is determined by the frequency f_{AOM} of the sonic wave applied to the AOM 18. When the frequency f_{AOM} is 10 MHz, in two-light flux mode, the frame rate fᵣ of the imaging element 38 becomes 30 MHz.

Therefore, the time tp required to acquire one image is the reciprocal of fᵣ, or tp=33 ns. Because three images are required per direction, the time required to acquire all images is roughly 1 μs.

Next, for the exposure time τₑₓₚ required in the imaging element 38, when the time for which the diffraction grating in the AOM 18 is substantially still is taken as T/1000, it becomes T=/f_{AOM}=100 ns. Therefore, the exposure time τₑₓₚ is made shorter than 0.1 ns, as follows:

τₑₓₚ<T/1000=0.1 ns (6)

Thus, according to this embodiment, phase switching of structured illumination on the specimen plane can be accelerated using a continuous-wave laser light source, which is less expensive than a pulse laser light source.

Note that two-light flux mode has been described as an example here, but this embodiment may also be applied in three-light flux mode. In this case, in order to change the mask so that the zero-order light beam passes through the mask and to vary the fringe phase of the structured illumination to substantially five phases, the timing of image-taking in the imaging element 38 may be set to an interval of T/5.

In this embodiment, the structured illumination IF is made substantially still by reducing the exposure time of the imaging element 38, but it is also possible to instead, for example, provide a high-speed shutter (mechanical shutter, liquid crystal panel-type shutter, or the like) in front of the imaging element 38 and to control the timing of fluorescence incident on the imaging element 38 with the high-speed shutter. In this case, since the exposure time of the camera (imaging element) can be increased, a more ordinary camera (imaging element) can be used.

### Seventh Embodiment

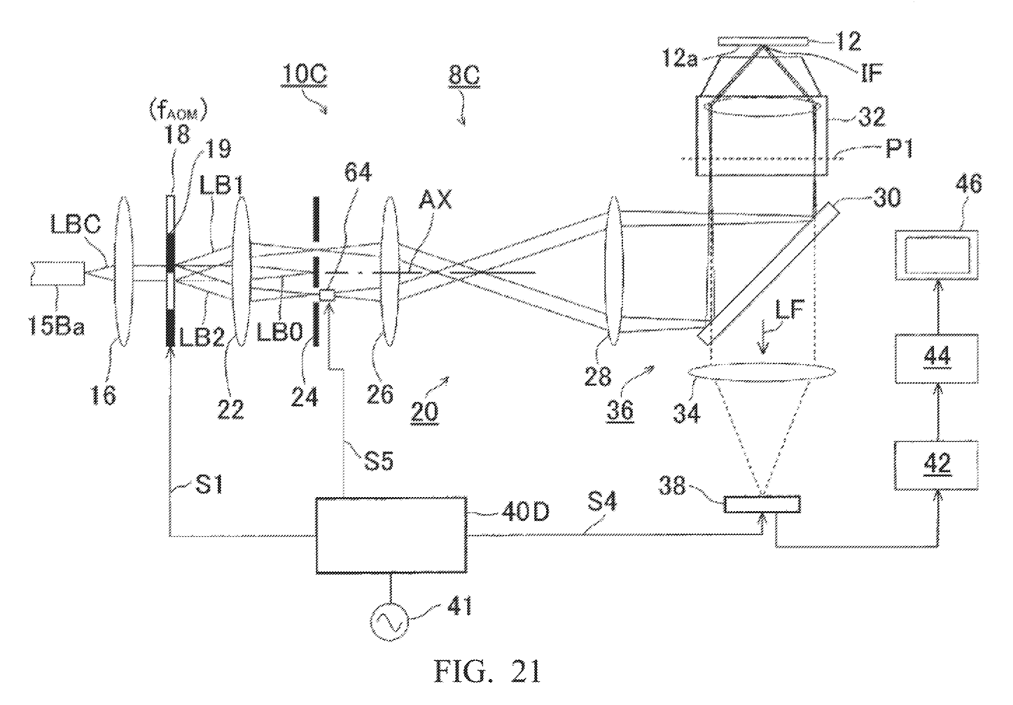

A seventh embodiment will be described in reference to FIGS. 21A to 23B. In this embodiment as well, a coherent light source 15AC constituted by a continuous-wave laser light source is used instead of the coherent light source 15A constituted by a pulse laser light source in FIG. 1A. In the sixth embodiment described above, phase modulation is performed by making the phase of the structured illumination, which varies temporally at high speed, to be substantially still by reducing the exposure time of the imaging element 38 and controlling the timing of image-taking.

However, depending on a case, there is a risk that the frequency f_{AOM} of the AOM 18 will be too high and the frame rate of an ordinary imaging element will not be able to keep up. Furthermore, when the imaging element 38 is exposed for a very short time much shorter than the time period T of the diffraction grating in the AOM 18, there is a risk that the SN ratio will decrease because the light quantity per image is small. In this embodiment, even in such a case, the phase switching of fringes generated on the specimen plane by structured illumination is matched to the frame rate of an ordinary imaging element by making the structured illumination still using phase modulation, so that the phase switching is sufficiently accelerated and the SN ratio is improved.

FIG. 21 illustrates a schematic configuration of a microscope 8C having an illumination apparatus 10C pertaining to this embodiment. Note that in FIG. 21, the same reference numerals are assigned to parts that correspond to FIG. 1A, and detailed descriptions thereof are omitted. In FIG. 21, a coherent continuous light beam LBC is collimated by a lens 16 and is incident on an AOM 18, and a zero-order light beam LB0 and ±first-order light beams LB1, LB2 and the like are emitted from the AOM 18. Here, two-light flux mode will be described as an example. In two-light flux mode, interference fringes of three phases need to be generated as structured illumination formed on a specimen plane by two diffracted light beams (here, ±first-order light beams LB1, LB2) generated from the AOM 18.

In this embodiment, of the diffracted light beams generated from the AOM 18, only the ±first-order light beams LB1, LB2 are condensed by a lens 22 and pass through the apertures of a mask 24. To modulate the phase of one of the two diffracted light beams that pass through the mask 24 (here, −first-order light beam LB2), a phase modulating element 64 constituted by, for example, an electro-optic element or electro-optic modulator (EOM) is provided on the mask 24. Also, a control apparatus 40D, which controls the operation of the AOM 18 and the imaging element 38, controls the operation of the phase modulating element 64. Any other configuration is the same as the first embodiment.

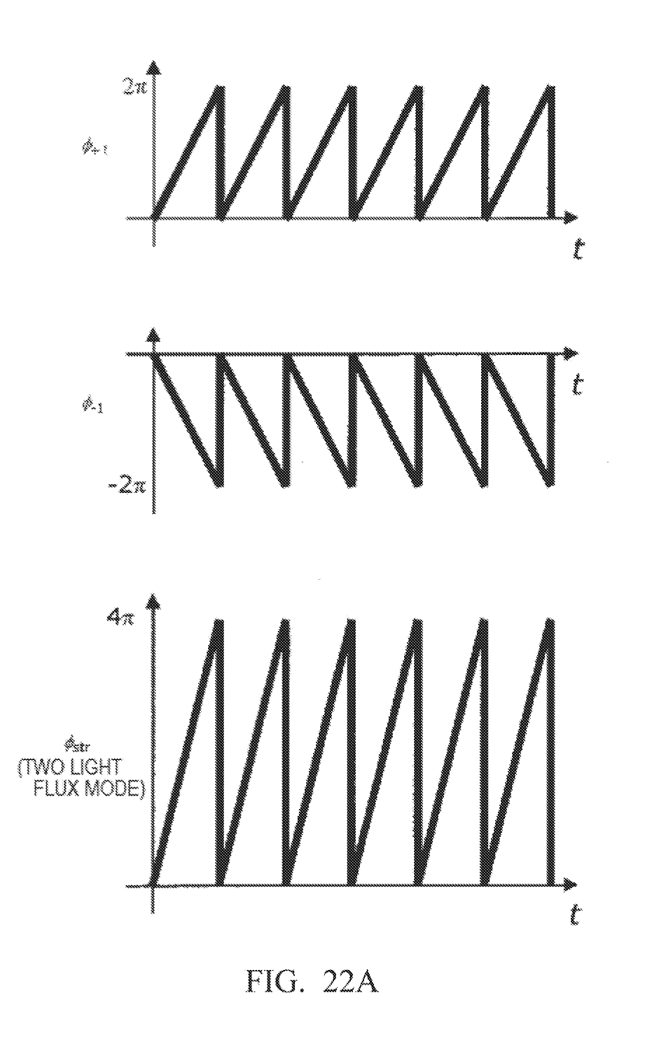

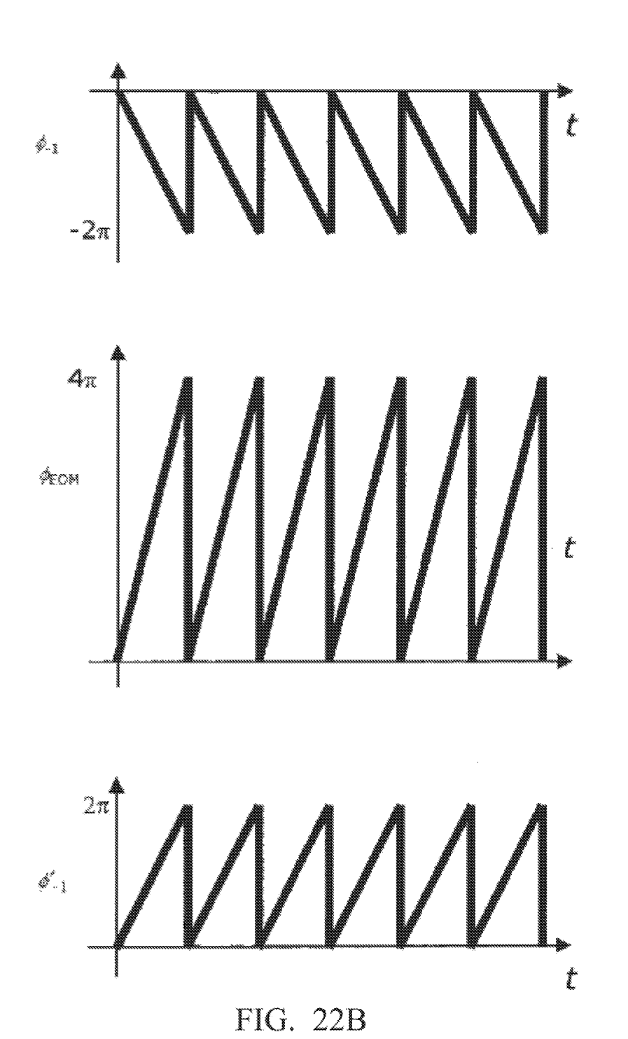

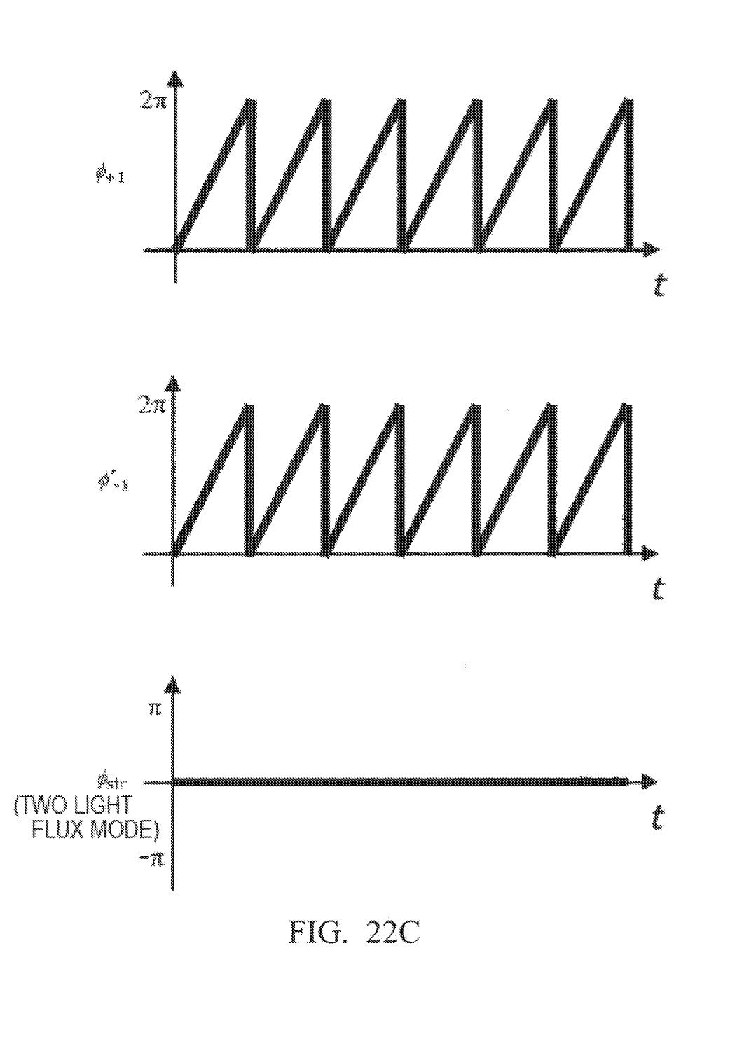

Phase modulation using the phase modulating element 64 in this embodiment will be described. First, when there is no phase modulating element 64, the phase relationship between the ±first-order light beams LB1, LB2 in FIG. 21 and the interference fringes (structured illumination IF) generated due to the interference of the ±first-order light beams LB1, LB2 are illustrated in FIG. 22A. In this embodiment, because the phase-type diffraction grating generated by the traveling-wave-type AOM 18 is used, the phases of diffracted light beams LB1, LB2 vary constantly over time. When the phase of the +first-order light beam LB1 is taken as φ₊₁ and the phase of the −first-order light beam LB2 is taken as φ₋₁, and the phase is looped back (wrapped) by 2π, they result in periodic functions of period T, which can be expressed as follows:

φ₊₁=2πt/T (7A)

φ₋₁=2πt/T (7B)

Here, T is the time period of the diffraction grating in the AOM 18, and when the frequency of the sonic wave of the AOM 18 is taken as f_{AOM}, it becomes t=1/f_{AOM}. The phase φₛₜᵣ of the structured illumination generated on the specimen plane 12a by the ±first-order light beams is as follows:

φₛₜᵣ=φ₊₁−φ₋₁=4πt/T (8)

Because time variation of the phases of the ±first-order light beams are inverted as illustrated in FIG. 22A, the phase of the structured illumination also varies continuously over time. Therefore, when there is no phase modulating element 64, the structured illumination moves continuously.

Next, a case where the phase modulating element 64 of this embodiment is provided in the optical path of the −first-order light beam LB2 (or +first-order light beam LB1) will be described. In this case, the structured illumination IF is made still by modulating the phase φ₋₁ of the −first-order light beam LB2 using a phase modulating element 64 constituted by an EOM. Because the frequency of a driving signal S5 constituted by an AC signal that drives the phase modulating element 64 is equal to the frequency f_{AOM} of the AOM 18, it is preferable that the phase modulating element 64 be controlled by the control apparatus 40D that controls the AOM 18.

FIG. 22B illustrates the phase φ₋₁ of the −first-order light beam LB2 before phase modulation, the phase φ_{EOM} provided to the −first-order light beam LB2 by the phase modulating element 64, and the phase φ′₋₁ of the −first-order light beam LB2 before and after phase modulation. The phase φ₋₁ of the −first-order light beam before phase modulation is the same as that in FIG. 22A (equation (7B)). At this time, in order to make the phase of the structured illumination constant, the phase of the +first-order light beam LB1 and the phase of the −first-order light beam LB2 may be made equal to each other. Thus, the phase difference between the two is constant at any time, and it becomes φₛₜᵣ=0.

If there is no phase modulating element 64, the phases of the ±first-order light beams are inverted as illustrated in FIG. 22A. Therefore, the structured illumination IF can be made still by inverting the phase of the −first-order light beam using the phase modulating element 64. Thus, the phase quantity φ_{EOM} provided to the −first-order light beam by the phase modulating element 64 is as follows:

φ_{EOM}=4πt/T=−2φ₋₁ (9)

At this time, the phase φ′₋₁ of the −first-order light beam after phase modulation is as follows:

φ′₋₁ =φ₋₁+φ_{EOM}=φ₋₁ (10)

By inverting the phase of the −first-order light beam using the phase modulating element 64 in this manner, it becomes φ₊₁=φ₋₁. As for the phase φₛₜᵣ of the structured illumination, since there is a difference in the phases of the two light beams as shown by equation (8), the phase difference is 0 and the structured illumination is still when the phases of the two are equal to each other. This situation is illustrated in FIG. 22C.

Up to now, the method in which the phase φₛₜᵣ of the structured illumination is 0 has been described, but it is also required that structured illumination with different phases be made still. To realize this, the phase quantity provided by the phase modulating element 64 may be varied. Equation (9) is generalized as follows:

φ_{EOM}=φ₀−2φ₋₁φ₀+4πt/T (11)

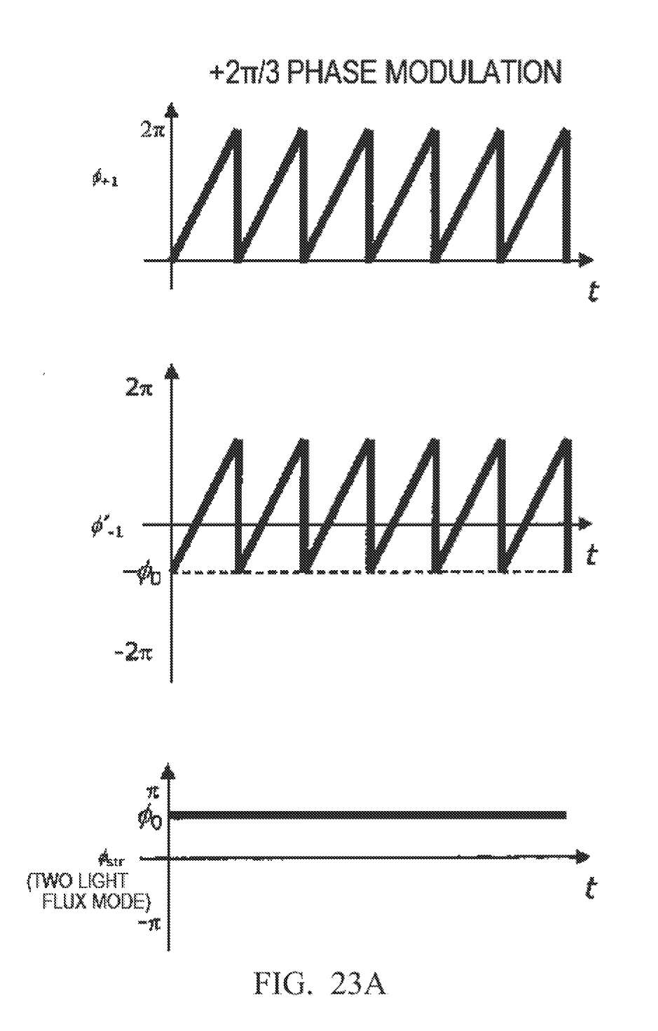

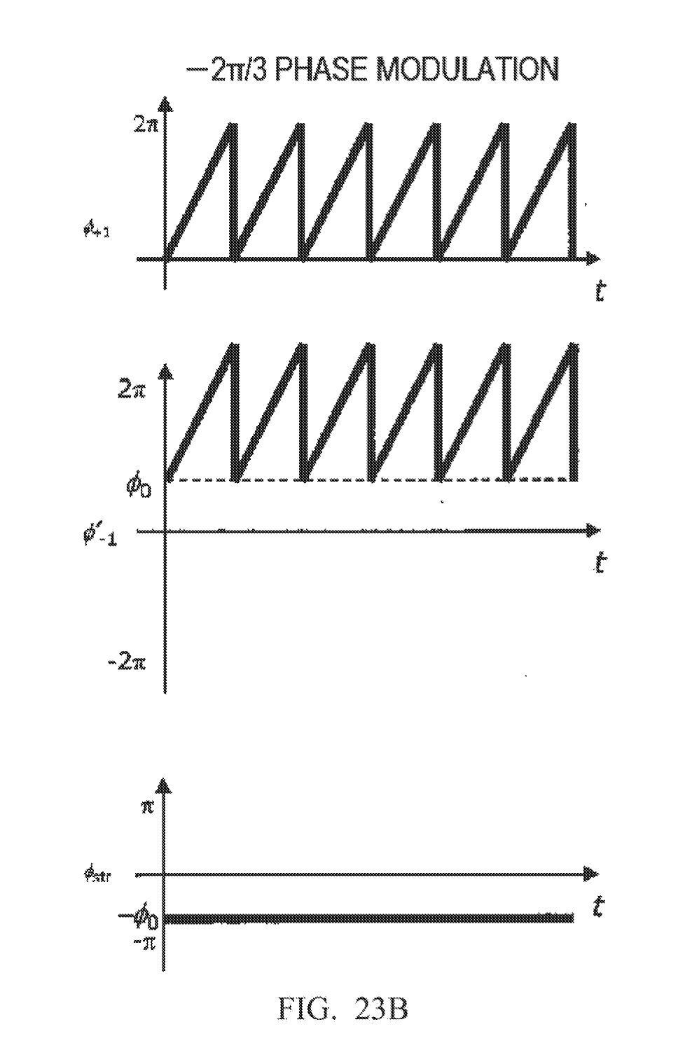

Here, φ₀ is the initial phase. In two-light flux mode, since structured illumination of three phases is required, φ₀ is either −2π/3, 0, or +2π/3. The relationships among the phase of the +first-order light beam, the phase of the −first-order light beam after phase modulation, and the phase of structured illumination when φ₀ is −2π/3 and +2πare illustrated in FIGS. 23A and 23B, respectively. The phase relationships when φ₀ is 0 are the same as those in FIG. 22C.

In this way, by performing phase modulation on diffracted light using the phase modulating element 64, the phase of the structured illumination IF on the specimen plane 12a can be made constant over time, thereby allowing the structured illumination to be still. Also, by changing the phase modulation of the phase modulating element 64, the phase of the structured illumination can be varied.

Therefore, the phase of the structured illumination may be varied by varying the phase quantity φ₀ provided by the phase modulating element 64 after making the structured illumination still for the integration time required by the imaging element 38. This operation may be repeated for the required number of phases.

In this way, the illumination apparatus 10C of this embodiment is an illumination apparatus for illuminating the specimen plane 12a (plane to be observed), including: a light source containing the end portion 15Ba for emitting a coherent continuous light beam LBC for observation, the AOM 18 for diffracting the continuous light beam LBC emitted from the end portion 15Ba, the phase modulating element 64 for modulating the phase of at least one diffracted light beam (here, −first-order light beam LB2) among a plurality of diffracted light beams generated from the AOM 18, and a condensing optical system 20 (illumination optical system) for condensing the diffracted light beam generated from the AOM 18 (here, +first-order light beam LB1) and the diffracted light beam modulated by the phase modulating element 64 (here, −first-order light beam LB2) on the specimen plane 12a in order to form structured illumination IF constituted by of phase-variable interference fringes.

According to this illumination apparatus 10C, because interference fringes formed using the AOM 18 and the phase modulating element 64 can be used as structured illumination, the phase of structured illumination can be switched at high speed and with high precision when performing structured illumination.

Furthermore, according to this embodiment, phase switching of structured illumination can be accelerated using an inexpensive continuous-wave laser light source and an ordinary imaging element 38. As a result, the apparatus configuration can be simplified and the benefit of cost cutting can be obtained.

Furthermore, in this embodiment, the phase modulating element 64 is disposed in proximity to the mask 24 (pupil plane of the condensing optical system 20). However, the phase modulating element 64 may also be disposed on a surface that relays the pupil plane by a relay optical system.

Additionally, when the coherence length of the continuous-wave laser (continuous light LBC) is short, the phase modulating element 64 may be disposed in both the ±first-order light beams. Also, the phase modulating element 64 may be disposed in the optical path of one of the diffracted light beams, and a glass plate having a similar refractive index and thickness may be disposed in the optical path of the other of the diffracted light beams.

Furthermore, an EOM is used as the phase modulating element 64 above, but the element is not limited provided that it can modulate the phase of light at high speed. Therefore, a phase plate having a continuous or periodic phase may be rotated at high speed instead of using the phase modulating element 64. Phase modulation may also be realized using a spatial light modulator.

Two-light flux mode has been described as an example here, but this embodiment may also be applied in three-light flux mode. In that case, the mask 24 needs to be changed so as to pass the zero-order light beam therethrough, and the phases of two light beams of the three light fluxes need to be modulated. Additionally, because the fringe phase of the structured illumination needs to be varied to five phases, the phase of the −first-order light beam may be varied by 2π/5 (time interval T/5) at a time by the driving signal S5 supplied to the phase modulating element 64.

In this embodiment, the traveling-wave-type AOM 18 is used for generating diffracted light beams from continuous light beams LBC. However, since the phase of one of the diffracted light beams is modulated by the phase modulating element 64, a standing-wave-type AOM or an ordinary diffraction grating may be used instead of the AOM 18. In this case, because the fringes that are still can be made to move by the phase modulating element 64, the phase of the structured illumination on the specimen plane 12a can made variable.

### Eighth Embodiment

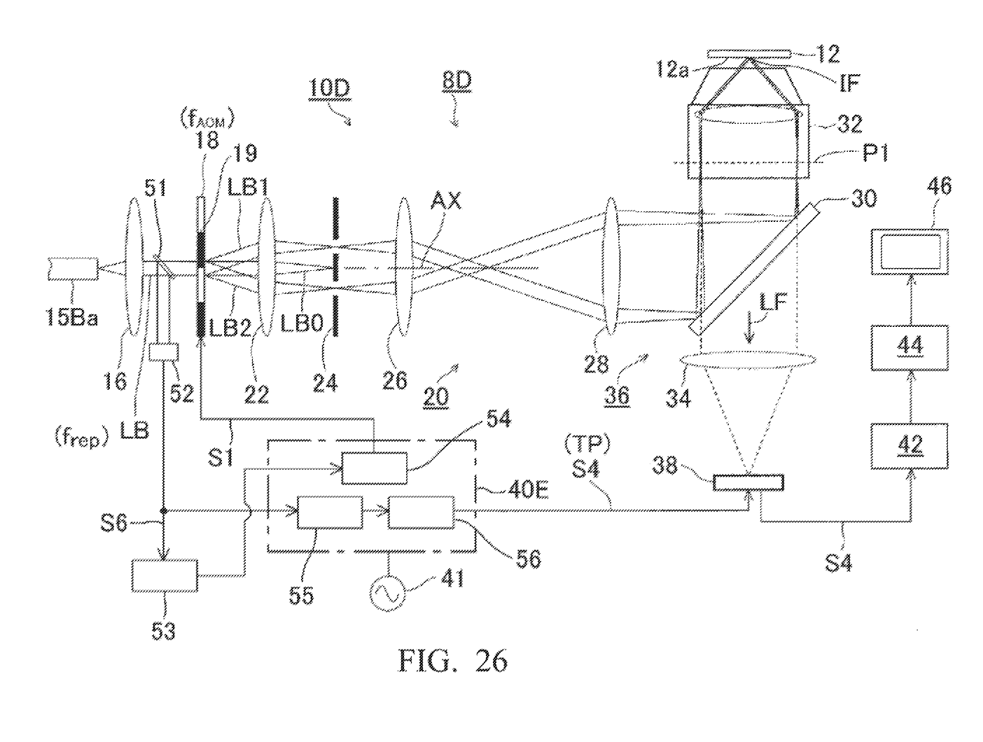

An eighth embodiment of the present invention will be described in reference to FIGS. 26 to 29A.

FIG. 26 illustrates a schematic configuration of a microscope 8D having an illumination apparatus 10D and a control apparatus 40E pertaining to this embodiment. Note that in FIG. 26, the same reference numerals are assigned to parts that correspond to those in FIG. 1A, and detailed descriptions thereof are omitted. In FIG. 26, a beam splitter 51 having a prescribed low reflectance is disposed between a lens 16 for collimating a light pulse LB emitted from an end portion 15Ba of an optical fiber and an AOM 18 on which the collimated light pulse LB is incident, and a photoelectric detector 52 constituted by, for example, a photodiode for detecting light pulses reflected by the beam splitter 51 is disposed.

Because faint light is sufficient as light detected by the photoelectric detector 52 and it is preferred that the intensity of the structured illumination IF be as high as possible, the reflectance of the beam splitter 51 may be fairly low. Therefore, a simple glass plate may be used as the beam splitter 51. Additionally, a polarizing beam splitter may be disposed instead of the beam splitter 51, and a half-wavelength plate, for example, may be disposed on the incident side of this polarizing beam splitter, and the intensity of the light incident on the photoelectric detector 52 may be configured so as to be adjustable by adjusting the rotation angle of the half-wavelength plate.

The photoelectric detector 52 preferably works in a wide bandwidth so as to be able to detect light in a frequency range that includes the repetition frequency fᵣₑₚ of the light pulse LB. When the cut-off frequency of a light receiving circuit (not illustrated) of the photoelectric detector 52 is taken as fc, it is preferable that the configuration be made so as to satisfy at least fc>fᵣₑₚ. Therefore, it is preferable that the light receiving circuit be configured using a transimpedance amplifier (TIA) control circuit or the like.

A light beam that is incident on the photoelectric detector 52 is converted to an electrical signal by photoelectric conversion, and becomes a detection signal S6 by the light receiving circuit (not illustrated). Therefore, this detection signal S6 has the same frequency fᵣₑₚ as the light pulse LB. The detection signal S6 is supplied to a spectrum analyzer 53 and the control apparatus 40E. In the control apparatus 40E, the detection signal S6 is converted to a signal form suitable for a trigger of the imaging element 38 by a waveform shaping circuit 55, and input to a variable delay circuit 56.

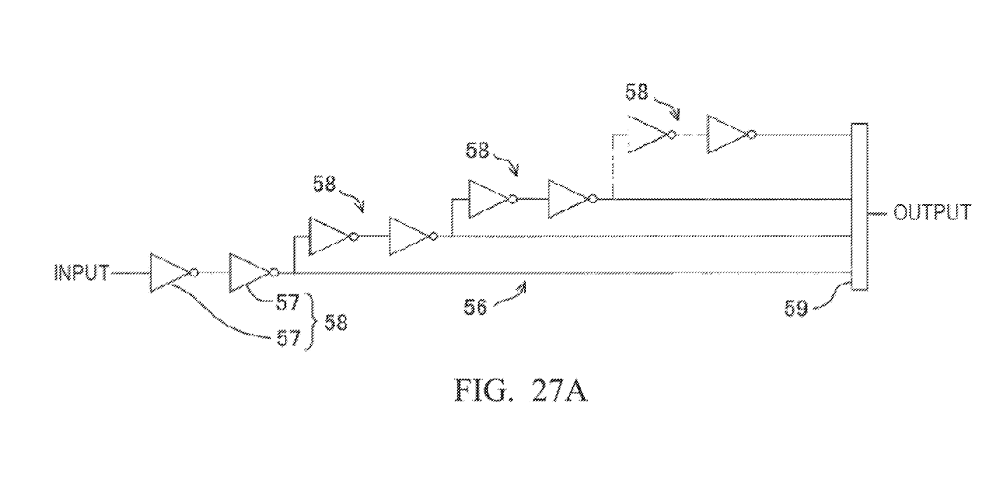

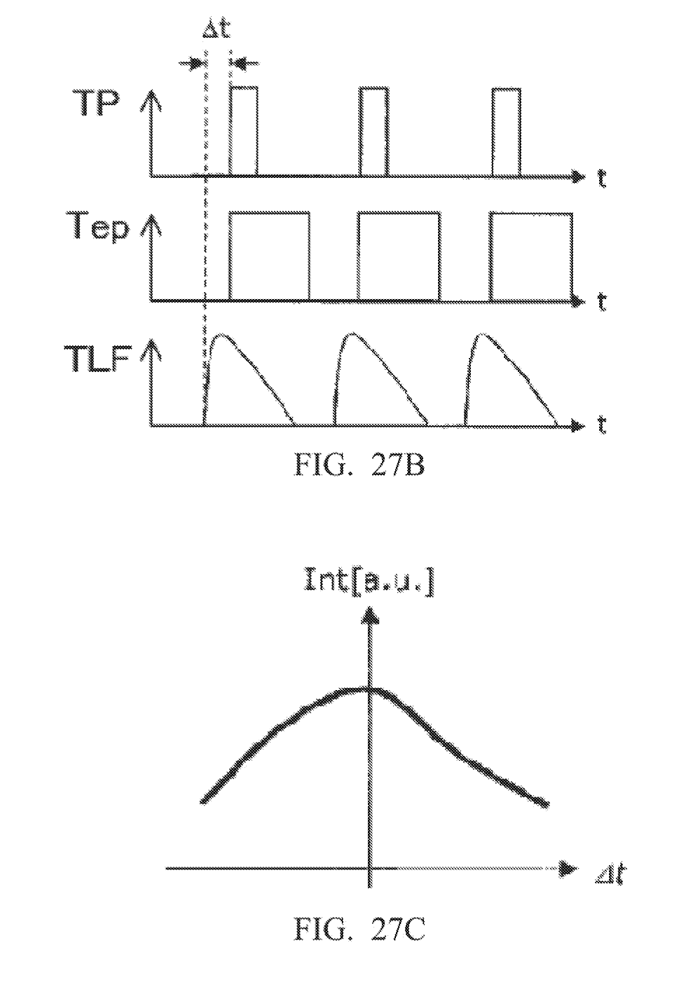

The variable delay circuit 56 is an electrical circuit for providing an optional time delay to an input electrical signal. As illustrated in FIG. 27 as an example, the variable delay circuit 56 is connected in series to a plurality of delay circuits 58 each constituted by of a pair of inverters 57, and is configured such that output signals of the delay circuits 58 are supplied in parallel to a switching element (selector) 59.

A single inverter 57 constitutes a NOT circuit, which inverts an input signal (digital signal). In short, when a high-level “1” (H) signal is input, a low-level “0” (L) signal is output, and when a low-level “0” signal is input, a high-level “1” signal is output. By connecting two of the inverters 57 in series, the output signal of the two inverters 57 (one delay circuit 58) has the same value as the input signal, but since time is required for circuit processing, a time delay occurs. By repeatedly outputting signals with a time delay provided by a certain delay circuit 58 to the switching element 59 and the next delay circuit 58, numerous output signals differing only in delay time are supplied in parallel to the switching element 59. The switching element 59 takes any one of the output signals, thereby allowing an appropriate delay time At to be provided to the input signal.

Alternatively, using a variable-capacitance capacitor such as a varicap capacitor instead of a plurality of inverter pairs (pairs of inverters 57), delay time At may be provided by varying the time constant of the RC circuit.

In FIG. 26, the output of the variable delay circuit 56 (trigger pulse TP) is the trigger input of the imaging element 38 (part of the control signal S4). Therefore, the frame rate of the imaging element 38 can be synchronized with the repetition frequency fᵣₑₚ of the light pulse LB. The spectrum analyzer 53 detects the frequency of the detection signal S6, and supplies the detected frequency to a control unit 54 in the control apparatus 40E. The control unit 54 controls the frequency f_{AOM} of the traveling wave (sonic wave) of the AOM 18 based on the frequency and/or the output of the signal oscillator 41.

Any other configuration and the principle in which the phase of the interference fringes generated by the structured illumination IF can be varied at high speed are the same as those of the microscope 8 in FIG. 1A (first embodiment). That is, the repetition frequency fᵣₑₚ of the light pulse LB is set according to equation (2) (fᵣₑₚ=m·f_{AOM}) relative to the frequency f_{AOM} of the AOM 18, using an integer m of 1 or greater.

Additionally, as an example, a case where the phase of the interference fringes generated by the structured illumination is varied one-third of a period at a time and three images of different phases are obtained will be considered. In this case, when the pitch of the diffraction grating by the sonic wave in the AOM 18 is taken as p, the variation quantity of the diffraction grating is p/3 (2π/3 by phase quantity).

Furthermore, in a state where the zero-order light beam is blocked by the mask 24 (two-light flux mode), the pitch ps of the structured illumination IF on the specimen plane 12a is expressed by equation (3) described above using the pitch p of the diffraction grating in the AOM 18 and the projection magnification β from the AOM 18 to the specimen plane 12a. Therefore, when the phase in the AOM 18 is varied by 2π/3 at a time as it is in this case, the phase shift of the structured illumination on the specimen plane 12a becomes 4π/3.

In this way, since the specimen 12 is excited with structured illumination IF of different phases, images required in the structured illumination microscope can be acquired at high speed by the imaging element 38 imaging the fluorescence LF generated by the excitation, without mechanical driving.

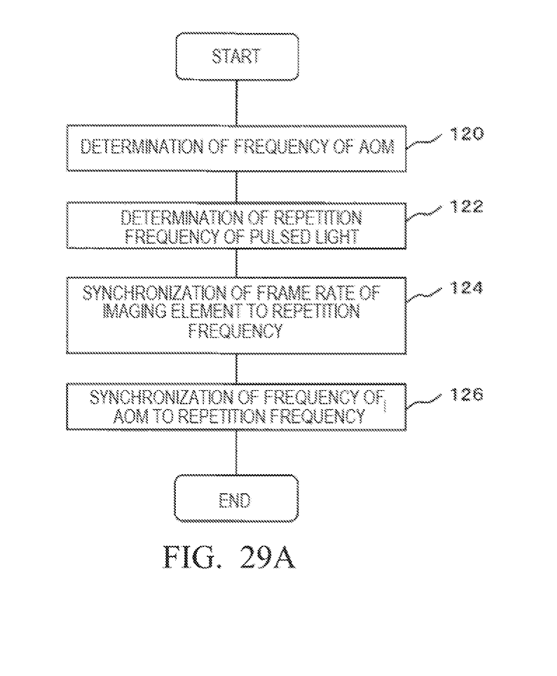

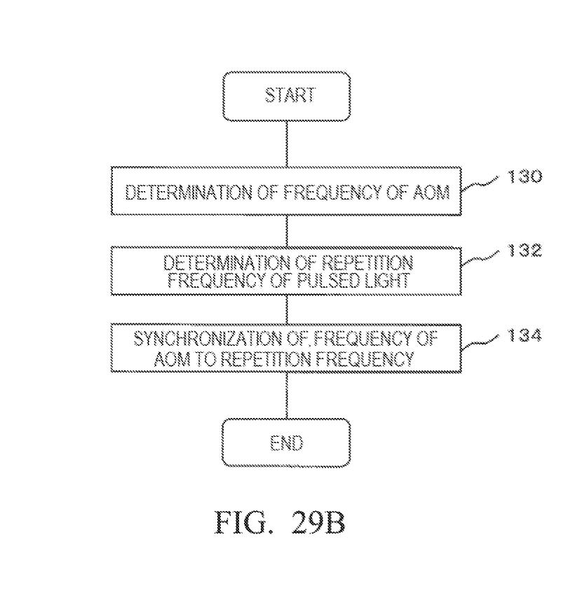

Below, an example of the illumination method and the observation method of this embodiment will be described in reference to a flowchart of FIG. 29A.

First, in step 120 of FIG. 29A, the frequency f_{AOM} of the AOM 18 is determined using equation (1) described above. In the next step 122, the repetition frequency fᵣₑₚ of the light pulse LB is determined using equation (2) described above. However, the method for obtaining a light pulse train of the repetition frequency fᵣₑₚ differs depending on how the light pulses LB are generated.

For example, when the light pulses LB are generated by direct modulation, the repetition frequency fᵣₑₚ is determined by the frequency of the electrical signal that drives the continuous-wave (CW) laser light source. Therefore, that frequency can be set to fᵣₑₚ. In this case, it is preferable that the same electrical signal output using the signal oscillator 41 (for example, a function generator) that drives the AOM 18 is supplied to the laser light source.

Furthermore, when the light pulses LB are generated by mode synchronization, the repetition frequency fᵣₑₚ is determined by the resonator length L of a laser resonator. When the speed of light is taken as c, the relationship between the frequency fᵣₑₚ and the resonator length L is expressed by the following equation:

fᵣₑₚ=c/(2L) (41)

Therefore, the resonator length L needs to be varied in order to vary the repetition frequency fᵣₑₚ. Thus, an electro-optic modulator (hereinafter, also called “EOM”) is inserted into the laser resonator as an example. The EOM is an element in which an electrode for voltage application is provided on a substrate such as lithium niobate or KTP crystal or the like, which can vary the refractive index of the crystal by voltage. When the thickness of the EOM crystal is taken as d and the refractive index is taken as n, the optical path length of a light beam that passes through the EOM crystal is nd. Therefore, the optical path length can be varied by varying the refractive index. Therefore, the frequency fᵣₑₚ can be set by varying the resonator length so as to result in the optimal frequency fᵣₑₚ, using the EOM.

In the next step 124, the frame rate fᵣ of the imaging element 38 is synchronized to the repetition frequency fᵣₑₚ of the light pulse. Here, control of the frame rate fᵣ of the imaging element 38 and the repetition frequency fᵣₑₚ of the light pulse LB will be described. To acquire images of different phases, as described in reference to FIGS. 5A to 5C, individual light pulses need to be independently detected by the imaging element 38. Therefore, the frame rate fᵣ of the imaging element 38 needs to be equal to the repetition frequency fᵣₑₚ.

Next, the method for adjusting the timing of the light pulse LB and image-taking by the imaging element 38 will be described. Because the fluorescence LF excited by the structured illumination IF of the light pulses LB reaches the imaging element 38 at the same frequency as the repetition frequency fᵣₑₚ of the light pulses, the imaging element 38 needs to be exposed when the fluorescence reaches the imaging element 38 in order to detect the fluorescence LF. Thus, the frame rate of the imaging element 38 and the phase of the fluorescent signal need to be appropriately set. In this embodiment, this is realized by using the variable delay circuit 56.

In the variable delay circuit 56, an appropriate delay time At as described above can be provided to the detection signal of light pulses obtained by the photoelectric detector 52. The delay time Δt in this case, as illustrated in FIG. 27B (horizontal axis is time t), is time from a time point when fluorescence LF is generated and the intensity TLF of the fluorescence LF becomes high (that is, the time point when the light pulse LB is detected by the photoelectric detector 52) until a trigger pulse TP indicating the start of image-taking is output (rises) from the variable delay circuit 56 in the control apparatus 40E to the imaging element 38. Exposure is performed in the imaging element 38 for a prescribed time immediately after the trigger pulse TP is output. In FIG. 27B, the time for which that exposure is performed (exposure time) is represented by the period during which a virtual signal Tep is in high level.

In this case, it is preferable that the stroke T (maximum value) of the delay time Δt and the resolution δt (the minimum unit time that can be set in the variable delay circuit 56) are as follows:

T>1/(2fᵣₑₚ) (42)

δt<tex/2 (43)

Where, tex is the exposure time of the imaging element 38, and this value is shorter than the repetition period tᵣₑₚ(=1/fᵣₑₚ) of the light pulses.

As illustrated in FIG. 27B, the phase between the exposure timing and the period during which fluoresce LF is generated can be varied by varying the delay time Δt. Therefore, images are acquired by the imaging element 38 while varying Δt, and, as illustrated in FIG. 27C, the At that results in the maximum intensity of the fluorescence LF to be imaged can be determined by plotting the intensity Int (any units) of those acquired images with respect to Δt, and the timing of exposure of the imaging element 38 and the period during which fluorescence LF is generated can be aligned.

Because the frequency f_{AOM} of the AOM 18 and the repetition frequency fᵣₑₚ of the light pulses are not synchronized at this time, there is a possibility of the intensity of the generated fluorescence LF being time-dependent when the structured illumination IF is projected as-is on the specimen 12. Thus, it is preferable that only one of the zero-order light beam, +first-order light beam, and −first-order light beam is allowed to pass through the mask 24. This is because the intensity distribution of diffracted light is always constant without depending on frequency f_{AOM}.

Furthermore, because the penetration length into a cell varies when the observation position of the cell varies, the optical path length of the light beam varies and the exposure timing also varies. However, even if the optical path length varies by 1 μm, this is equivalent to 3.3 fs when converted to time variation, and this is considered to be on an order that can be ignored compared to the time interval of the light pulses. Furthermore, it is preferable that a fluorescent body does not readily fade in color.

In the next step 126, the frequency f_{AOM} of the AOM 18 is synchronized to the repetition frequency fᵣₑₚ of the light pulses. This means that the repetition frequency of the light pulses is used as the master frequency. Thus, in FIG. 26, the repetition frequency fᵣₑₚ of the light pulses is measured by performing frequency analysis, by the spectrum analyzer 53, on the detection signal S6 detected via the photoelectric detector 52, and the measurement result is supplied to the control unit 54 of the control apparatus 40E.

The control unit 54 controls the signal oscillator 41 so that the signal oscillator 41 oscillates a sinusoidal electrical signal having a frequency expressed by the following equation which is 1/m times of the measured repetition frequency, and the control unit 54 drives the AOM 18 by the oscillated electrical signal (driving signal S1).

f_{AOM}=fᵣₑₚ/m (44)

Here, m is the required number of phase feed, provided that m is an integer of 1 or greater, and the AOM 18 functions as a diffraction grating by that signal. When a light pulse LB is incident on the AOM 18, a diffracted light beam is generated from the AOM 18, and structured illumination IF is projected on the specimen surface 12a. Fluorescent molecules thus excited generate fluorescence LF and form an image by structured illumination on the imaging element 38. This image by structured illumination is acquired at fixed time intervals determined by the frame rate of the imaging element 38. At this time, a mirror may be used as the specimen 12 instead of fluorescent molecules.

In the imaging element 38, images are acquired in a time-lapse method and the fringe phase of each of the images (phase of the interference fringes) is analyzed. At this time, the repetition frequency of the light pulse and the frame rate of the imaging element 38 are in a synchronized state by the method described above. Therefore, it is expected that, of the acquired images, the phases of the n^{th} image (phase φₙ) and the n+j·m^{th} image (phase φₙ₊ⱼₘ) coincide (j=1, 2, 3, . . . ). When the phase difference of each of the images is taken as Δφ, Δφ is as follows:

Δφ=φₙ₊ⱼₘ−φₙ (45)

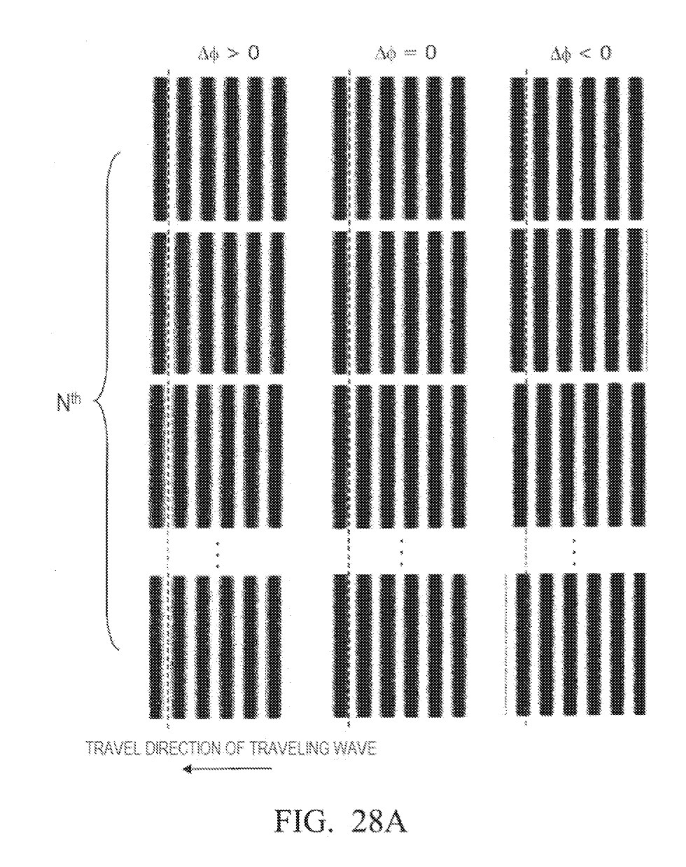

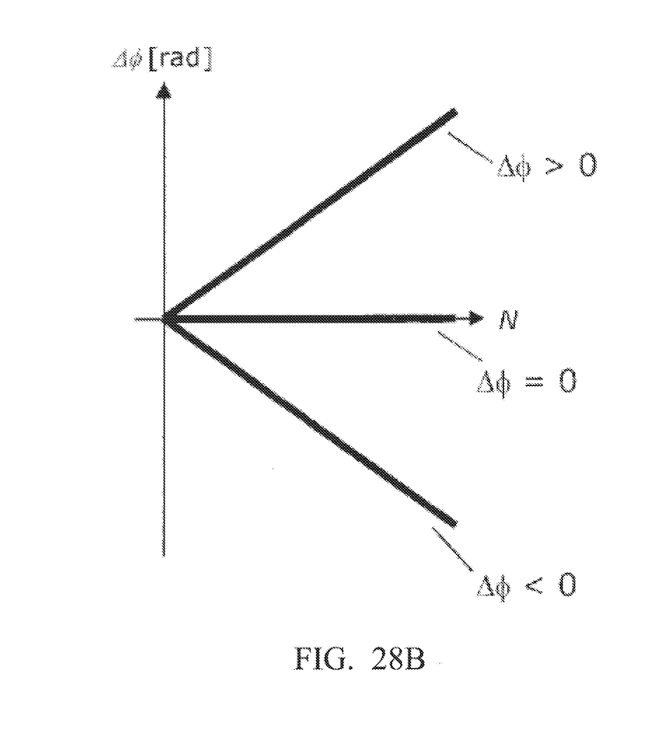

When Δφ=0, there is no phase difference in the images, and the same image is acquired regardless of what number image it is, as illustrated by images when Δφ=0 in FIG. 28A. This shows that equation (44) holds true. Therefore, in this state, the phase differences between the n^{th}, n+1^{st}, . . . , n+m^{th} images are set to the desired fringe phase 2π/m, and correct phase feed of structured illumination can be realized. When Δφ≠0, equation (44) does not hold true, and correct phase feed cannot be achieved in this state.

For example, when Δφ>0, it satisfies f_{AOM}>fᵣₑₚ/m, and, as illustrated by the images when Δφ>0 in FIG. 28A, as more time elapses, that is, as the number of acquired images increases, the time lapse images in this case (N images taken with a constant period, provided that N is an integer of 2 or greater) shift to the left, which is the direction of travel of the fringes.

Additionally, when Δφ<0, it satisfies f_{AOM}<fᵣₑₚ/m, and, as illustrated by the images when Δφ<0 in FIG. 28A, as more time elapses, that is, as the number of acquired images increases, the time lapse images shift to the right, which is the direction opposite the direction of travel of the fringes.

The relationship between the phase difference Δφ and the number of acquired images N when the m·N^{th} image has been acquired is illustrated in FIG. 28B. From FIG. 28B, the frequency magnitude relationship can be known from the Δφ magnitude relationship. Therefore, when Δφ<0, the frequency f_{AOM} of the signal oscillator 41 gets larger, and when Δφ>0, the frequency f_{AOM} of the signal oscillator 41 gets smaller. In this state, continuous images are again acquired and Δφ is measured. By repeating this until Δφ converges to 0, the relationship of equation (44) holds true and correct phase feed can be achieved.

Here, only one image among a set of m images is used, but when pulse jitter becomes problematic, the time dependence of the phase may be adjusted using a plurality of or all images.

Also, when the frequency f_{AOM} of the AOM 18 is varied using the control apparatus 40E, the pitch of the diffraction grating generated by the AOM 18 can also be varied. In this case, the repetition frequency of the light pulses also needs to be varied.

Here, as described above, the method for varying the repetition frequency fᵣₑₚ of the light pulses differs depending on how the light pulses are generated. When light pulses are generated by direct modulation, the frequency of the electrical signal that drives the CW laser light source is set so as to result in a suitable frequency fᵣₑₚ, and first, synchronization with the imaging element 38 is performed, and then the frequency f_{AOM} is adjusted as described in reference to FIGS. 27A and 27B. On the other hand, when the light pulses are generated by mode synchronization, the resonator length is varied so as to result in a suitable frequency fᵣₑₚ by controlling the voltage applied to the EOM in the laser resonator. After that, first, synchronization with the imaging element 38 is performed, and then the frequency f_{AOM} of the AOM 18 is adjusted as described in reference to FIGS. 27A and 27B.

As described above, according to this embodiment, because the frequency fᵣₑₚ of the light pulses LB is adjusted to be m times the frequency f_{AOM} of the sonic traveling wave of the AOM 18, provided that m is an integer of 2 or greater, the first phase (φₙ) of the interference fringes formed on the specimen plane 12a (plane to be observed) is detected in synchronization with the light pulses LB, and after the first phase is detected, the second phase (φₙ₊ⱼₘ) of the interference fringes formed on the specimen plane 12a is detected in synchronization with the j·m^{th} light pulse LB, provided that j is an integer of 1 or greater, and the frequency f_{AOM} of the AOM 18 is adjusted so as to reduce the phase difference Δφ between the first phase and the second phase. Therefore, the frequency fᵣₑₚ of the light pulses LB can be efficiently adjusted so as to be m times the frequency f_{AOM} of the AOM 18.

Furthermore, up to now, the repetition frequency fᵣₑₚ of the light pulses has been considered the reference, but of course the frequency f_{AOM} of the AOM 18 may be considered the reference. That is, the frequency fᵣₑₚ of the light pulses may be adjusted so as to reduce that phase difference Δφ.

In this case, a signal having a frequency m times the frequency f_{AOM} of the driving signal S1 input to the AOM 18 determined from equation (1) is used as the trigger of the imaging element 38, and the timing of exposure of the imaging element 38 and the light pulses are aligned by varying the phase of that signal. After that, it is preferable that the repetition frequency fᵣₑₚ be adjusted to align with the frequency f_{AOM} by acquiring fringe images and performing phase analysis. Each of these adjustment methods is as described above.

Furthermore, for example, the frequency fᵣₑₚ of the light pulses LB may also be adjusted so as to be 1/N times, provided that N is an integer of 1 or greater, the frequency f_{AOM} of the sonic traveling wave of the AOM 18. In this case, the AOM 18 may be driven by a driving signal of a frequency N times the frequency of the light pulses LB detected by the spectrum analyzer 53.

### Ninth Embodiment

A ninth embodiment will be described in reference to FIGS. 29B to 31B. In the eighth embodiment described above, the frequency adjustment method is described for the case where the frequency f_{AOM} of the AOM 18 is lower than the repetition frequency fᵣₑₚ of the light pulses (f_{AOM}<fᵣₑₚ), that is, the case where individual light pulses need to be independently detected. In this embodiment, the modulation method for the case where fᵣₑₚ=f_{AOM}/N will be described. Here, N is an integer of 1 or greater. The case where N=1 will be described as an example below.

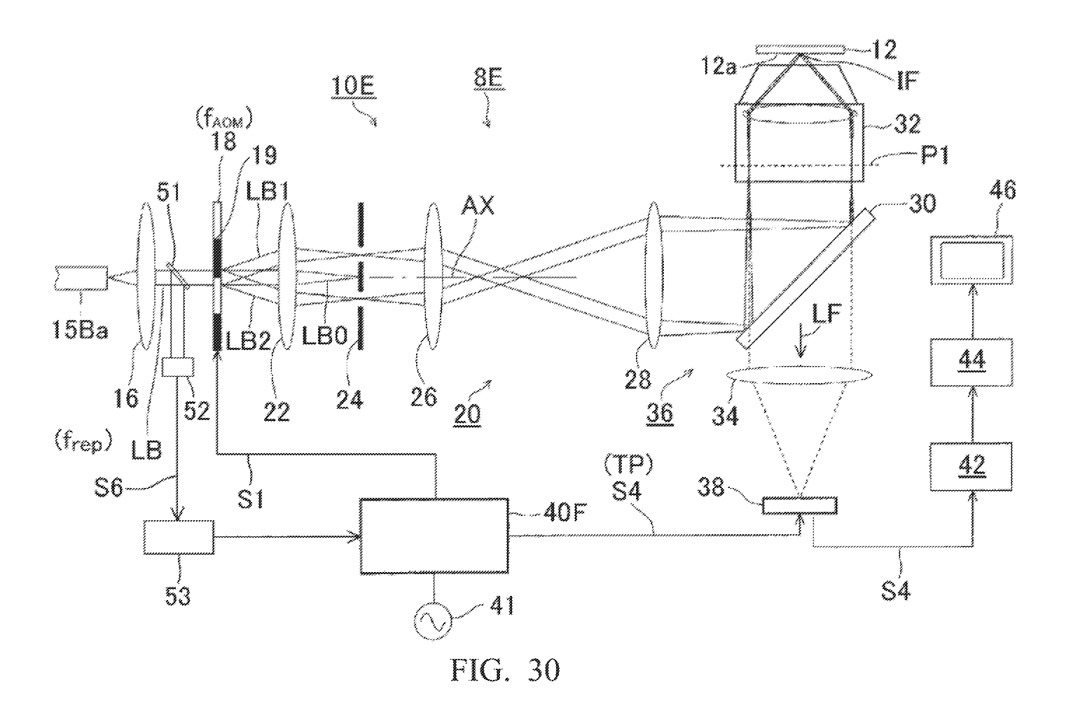

FIG. 30 illustrates a schematic configuration of a microscope 8E having an illumination apparatus 10E and a control apparatus 40F pertaining to this embodiment. Note that in FIG. 30, the same reference numerals are assigned to parts that correspond to those in FIG. 1A and FIG. 26, and detailed descriptions thereof are omitted.

In FIG. 30, a beam splitter 51 is disposed between a lens 16 for collimating light pulses LB emitted from an end portion 15Ba of an optical fiber and an AOM 18 on which the collimated light pulses LB are incident, and a photoelectric detector 52 for detecting light pulses reflected by the beam splitter 51 is disposed. A light beam that is incident on the photoelectric detector 52 is converted to an electrical signal by photoelectric conversion, and becomes a detection signal S6 having the same frequency fᵣₑₚ as the light pulses LB by a light receiving circuit (not illustrated), and the detection signal S6 is supplied to a spectrum analyzer 53.

Any other configuration and the principle of varying, at high speed, the phase of the interference fringes generated by the structured illumination IF are the same as those of the microscope 8 in FIG. 1A (first embodiment).

In this embodiment, a plurality of light pulses (images of fluorescence LF) are integrated by the imaging element 38, and one image is generated. Although there are many techniques for varying the phase of interference fringes, here, an example of the adjustment method of this embodiment is described in reference to the flowchart in FIG. 29B, citing as an example a technique of varying the phase of the interference fringes by varying the phase of the driving signal S1 that drives the AOM 18.

First, in step 130 in FIG. 29B, similar to the eighth embodiment above, the frequency f_{AOM} of the AOM 18 is determined by equation (1) above. Then, in step 132 in this embodiment, the repetition frequency fᵣₑₚ of the light pulses LB is set to be the same as the frequency f_{AOM} of the AOM 18 (fᵣₑₚ=f_{AOM}).

In this embodiment, because the imaging element 38 integrates numerous light pulses (images of fluorescence LF) during the exposure time, this effect makes it unnecessary to synchronize the frame rate fᵣ of the imaging element 38 with the repetition frequency fᵣₑₚ. However, synchronization is preferable when the number of light pulses during the exposure time is extremely small.

In the next step 134, the repetition frequency fᵣₑₚ and the frequency f_{AOM} of the AOM 18 are synchronized. The images taken by the imaging element 38 are constituted of the sum of the fluorescence LF excited by the structured illumination IF generated by the individual light pulses for the number of light pulses. Therefore, when the frequencies fᵣₑₚ and f_{AOM} are synchronized, the structured illumination IF generated by the individual light pulses is entirely the same.

However, when the frequencies fᵣₑₚ and f_{AOM} are not synchronized, the diffraction grating in the AOM 18 does not seem still to the light pulses LB, and the diffraction grating moves at the beat frequency f_{beat}(=fᵣₑₚ−f_{AOM}) of the two. Therefore, the phase of the structured illumination differs for each light pulse. As a result, the contrast of the image obtained by integrating them ends up decreasing.

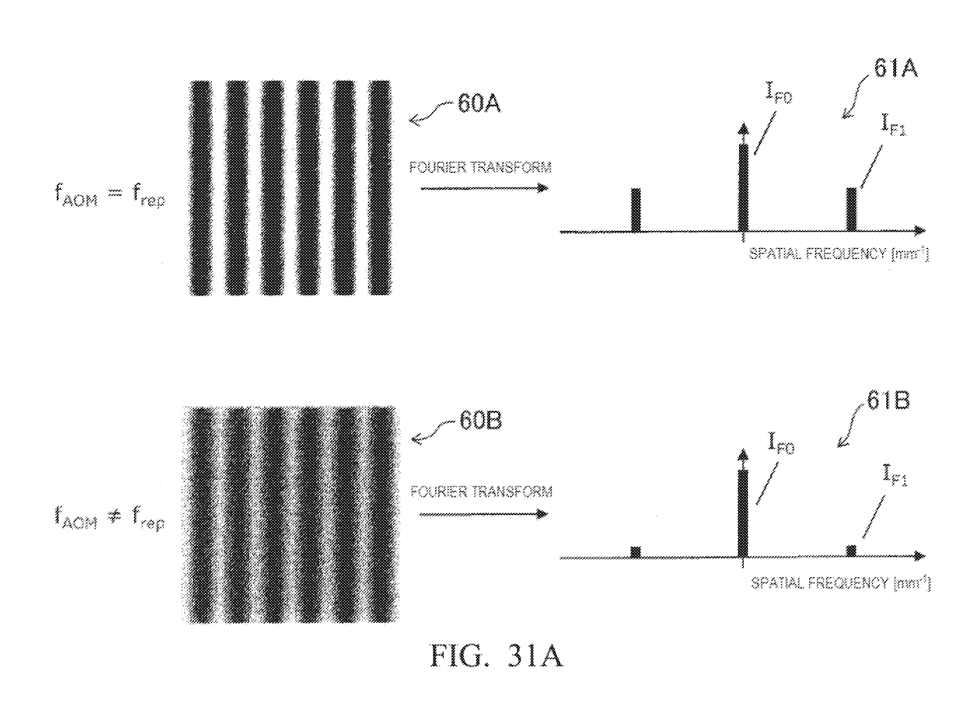

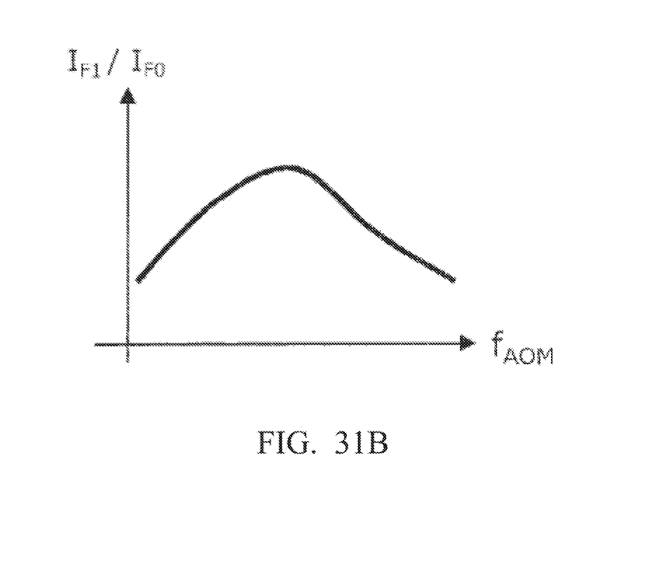

Thus, in this embodiment, a two-dimensional Fourier transform is performed on acquired images 60A, 60B as illustrated in FIG. 31A in order to synchronize the repetition frequency fᵣₑₚ and the frequency f_{AOM} of the AOM 18. Then, the ratio RF of the zero-order (DC) component I_{F0} and the first-order component I_{F1} of the Fourier spectra 61A, 61B is calculated, as expressed by the following equation:

RF=I_{F1}/I_{F0} (46)

Then, by finely adjusting the frequency f_{AOM} of the AOM 18 by the signal oscillator 41 so that the ratio RF reaches a maximum as illustrated in FIG. 31B, the frequencies fᵣₑₚ and f_{AOM} can be synchronized.

When the phase of the structured illumination IF is varied, the phase of the frequency f_{AOM} of the AOM 18 is varied by the signal oscillator 41. The phase variation quantity at this time is 2π/m, provided that m is an integer of 2 or greater.

As described above, according to this embodiment, because the frequency fᵣₑₚ of the light pulses is adjusted (synchronized) so as to be the same as the frequency f_{AOM} of the sonic traveling wave of the AOM 18, a plurality of images of the interference fringes formed on the specimen plane 12a (plane to be observed) are detected and integrated in synchronization with the light pulses, and the frequency f_{AOM} is adjusted so as to increase the contrast of the integrated interference fringes. Therefore, the frequency fᵣₑₚ of the light pulses and the frequency f_{AOM} of the AOM 18 can be synchronized efficiently and with high precision.

This adjustment may also be performed by keeping the frequency f_{AOM} of the AOM 18 constant and varying the repetition frequency fᵣₑₚ of the light pulses LB. In this way, the optimum structured illumination can be generated by adjusting various parameters.

Additionally, in this embodiment, a technique for varying the phase of the driving signal S1 of the AOM 18 has been described as a means for phase modulation of structured illumination, but the adjustment method is not limited to this technique. For example, this adjustment technique can also be applied in a case where phase modulation of structured illumination is realized by varying the timing of the AOM and the light pulses by inserting an EOM (electro-optic modulator) in the optical path between the laser light source (not illustrated) and the AOM 18 and modulating the refractive index by the EOM.

### Tenth Embodiment

A tenth embodiment will be described. In this embodiment, in the microscope 8 in FIG. 1A, a coherent light source 15AC constituted by a continuous-wave (CW) laser light source is used instead of the coherent light source 15A constituted by a pulse laser light source. The principle of the method for observing the specimen 12 using structured illumination IF generated using continuous light beams LBC (CW laser light) output from the coherent light source 15AC is as described in the sixth embodiment above.

Here, two-light flux mode will be described as an example. Interference fringes of three phases need to be generated as the interference fringes generated by structured illumination IF.

In FIG. 1A, an AC signal (driving signal S1) is applied from the signal oscillator 41 to the AOM 18 via the control apparatus 40. This frequency is f_{AOM}, and the time period is T(=1/f_{AOM}). The interference fringes formed on the specimen plane 12a constantly move with the time period T as one period, but by making the exposure time τₑₓₚ of the imaging element 38 sufficiently shorter than the period T, the moving interference fringes can be made to appear to be still. Furthermore, in two-light flux mode, by setting the frame rate fᵣ of the imaging element 38 to 3f_{AOM} and acquiring three images with the exposure time τₑₓₚ during one fringe period T, it is possible to acquire, at high speed, the fluorescent images excited by structured illumination of different phases required in a structured illumination microscope.

When performing adjustment, the frequency f_{AOM} of the AOM 18 is set as a base frequency, and an electrical signal I_{trig} of a frequency which is m times, provided that m is an integer of 2 or greater, the frequency f_{AOM} of the AOM 18 is generated by a function generator (not illustrated) which is installed inside of the control apparatus 40. This electrical signal I_{trig} is used as the trigger of the imaging element 38. Similar to the eighth embodiment, correct phase feed can be realized by acquiring images with the same phases and examining the phase difference Δφ between the phases, then finely adjusting the frequency of the electrical signal I_{trig} so as to minimize the phase difference.

According to this embodiment, light beams emitted from the coherent light source 15AC is continuous light beams LBC (CW laser), and, similar to the eighth embodiment, the first phase of the interference fringes formed on the specimen plane 12a (plane to be observed) is detected in synchronization with a trigger pulse of a frequency substantially m times, provided that m is an integer of 2 or greater, the frequency f_{AOM} of the sonic traveling wave, and after the first phase is detected, the second phase of the interference fringes formed on the specimen plane 12a is detected in synchronization with a j·m^{th} trigger pulse, provided that j is an integer of 2 or greater, and the frequency of the trigger pulse (electrical signal I_{trig}) is adjusted so as to reduce the phase difference between the first phase and the second phase. By this adjustment method, images of fluorescence LF, whose phases vary in response to movement of the diffraction grating in the AOM 18, can be taken with correct timing by the imaging element 38, and the specimen 12 can be observed with high precision.

Furthermore, in the first to tenth embodiments described above, the orientation switching mechanism of the phase-type diffraction grating in the AOMs 18, 18A, the phase control mechanism of that diffraction grating or structured illumination, and the like are examples, and any configuration and combination thereof may be used without limitation to the embodiments described above.

Additionally, in the above embodiments, the case where ±first-order light beams (or zero-order light beam and ±first-order light beams) are used among the diffracted light beams generated by the phase-type diffraction grating generated in the traveling-wave-type AOMs 18, 18A has been described, but, for example, ±second-order light beams or ±third-order light beams or the like may be used instead of the ±first-order light beams. In that case, a measure to increase the power of the laser light beam may be required because light intensity is lower than that of the first-order light beams.

Furthermore, in the above embodiments, the present invention has been applied to microscopes for performing fluorescent observation using structured illumination, but the present invention can be applied to ordinary microscopes that use structured illumination.

Thus, the present invention is not limited to the above embodiments, and may take on a variety of configurations without departing from the spirit and scope of the present invention.

1. An illumination apparatus comprising:
a traveling wave forming unit that is disposed in an optical path of a light flux emitted from a light source unit and that is configured to form a sonic traveling wave in a direction traversing the emitted light flux; and
an illumination optical system that is configured to form, on a plane to be observed, position-variable interference fringes caused by a plurality of diffracted light beams generated from the traveling wave forming unit.

2. The illumination apparatus according to claim 1,
wherein the light source unit emits a pulsed light beam; and
the illumination apparatus further comprises a synchronization controller configured to synchronize emission of the pulsed light beam from the light source unit and a phase of the sonic traveling wave formed in the traveling wave forming unit.

3. The illumination apparatus according to claim 1,
wherein the light source unit emits a pulsed light beam;
wherein a repetition frequency of the pulsed light beam is 1/N times a frequency of the sonic traveling wave, provided that N is an integer of 1 or greater; and
the illumination apparatus further comprises a timing controller configured to relatively control timing with which the pulsed light beam is incident on the traveling wave forming unit.

4. The illumination apparatus according to claim 1, wherein the light source unit emits a pulsed light beam; and
wherein a repetition frequency of the pulsed light beam is an integral multiple of a frequency of the sonic traveling wave.

5. The illumination apparatus according to claim 4, further comprising:
a pulsed light selector configured to select a pulsed light beam of prescribed timing among the pulsed light beam.

6. The illumination apparatus according to claim 1, further comprising:
a phase modulator configured to modulate a phase of at least one diffracted light beam among the plurality of diffracted light beams generated from the traveling wave forming unit.

7. The illumination apparatus according to claim 1,
wherein the traveling wave forming unit includes an acousto-optic element capable of forming a sonic traveling wave from a plurality of mutually different directions within a plane perpendicular to an optical axis of the illumination optical system.

8. A microscope for observing a plane to be observed, the microscope comprising:
an illumination apparatus described in claim 1 that is configured to illuminate the plane to be observed;
an image-forming optical system that is configured to form images by a light beam generated from the plane to be observed;
an imaging element that is configured to detect the images formed by the image-forming optical system; and
a calculating unit that is configured to process information on the plurality of images detected by the imaging element in order to determine an image of the plane to be observed.

9. The microscope according to claim 8, further comprising:
an imaging controller that is configured to control the imaging element to detect an image formed by the image-forming optical system when a phase of the interference fringes formed on the plane to be observed becomes a plurality of different phases with each other.

10. An illumination method for illuminating a plane to be observed, comprising the steps of:
emitting a light beam from a light source; and
forming phase-variable interference fringes on the plane to be observed, the phase-variable interference fringes being constituted by a plurality of diffracted light beams generated from a traveling wave forming unit, the traveling wave forming unit being disposed in an optical path of an emitted light flux and having a sonic traveling wave formed in a direction traversing the emitted light flux.

11. The illumination method according to claim 10,
wherein the light beam is a pulsed light beam; and
wherein the sonic traveling wave is formed in synchronization with emission of the pulsed light beam.

12. The illumination method according to claim 10,
wherein the light beam is a pulsed light beam;
wherein a repetition frequency of the pulsed light beam is 1/N times a frequency of the sonic traveling wave, provided that N is an integer of 1 or greater; and
wherein timing with which the pulsed light beam is incident on the traveling wave forming unit is relatively controlled.

13. The illumination method according to claim 10, wherein the light beam is a pulsed light beam; and
wherein a repetition frequency of the pulsed light beam is an integral multiple of a frequency of the sonic traveling wave.

14. The illumination method according to claim 13,
wherein a pulsed light beam of prescribed timing is selected from the pulsed light beam.

15. The illumination method according to claim 10,
wherein at least a phase of one diffracted light beam among the plurality of diffracted light beams is modulated.

16. An observation method for observing a plane to be observed, comprising the steps of:
illuminating the plane to be observed by an illumination method described in claim 10,
forming images via an image-forming optical system by a light beam generated from the plane to be observed;
detecting the images formed by the image-forming optical system; and
processing information on the detected plurality of images to determine an image of the plane to be observed.

17. The observation method according to claim 16, further comprising the steps of:
wherein the detection of the images formed by the image-forming optical system is performed by the imaging element when a phase of the interference fringes formed on the plane to be observed becomes a plurality of different phases with each other.

18. The illumination method according to claim 13,
wherein in order to perform adjustment such that the repetition frequency of the pulsed light beam is m times the frequency of the sonic traveling wave provided that m is an integer of 2 or greater, a first phase of interference fringes formed on the plane to be observed in synchronization with the pulsed light beam is detected,
a second phase of interference fringes formed on the plane to be observed in synchronization with the pulsed light beam of a j·m^{th} pulse provided that j is an integer of 1 or greater is detected after the first phase is detected, and
the repetition frequency of the pulsed light beam or the frequency of the sonic traveling wave is adjusted so as to reduce a difference between the first phase and the second phase.

19. The illumination method according to claim 12,
wherein the repetition frequency of the pulsed light beam is the same as the frequency of the sonic traveling wave; and
wherein, in order to perform adjustment so that the repetition frequency of the pulsed light beam becomes the same as the frequency of the sonic traveling wave, the interference fringes formed on the plane to be observed are detected a plurality of times in synchronization with the pulsed light beam and integrated, and
the repetition frequency of the pulsed light beam or the frequency of the sonic traveling wave is adjusted so as to increase contrast of the integrated interference fringes.

20. The illumination method according to claim 10,
wherein light beam emitted from the light source unit is a continuous light beam;
wherein a first phase of interference fringes formed on the plane to be observed is detected in synchronization with a trigger signal which is a frequency substantially m times a frequency of the sonic traveling wave provided that m is an integer of 2 or greater;
wherein a second phase of interference fringes formed on the plane to be observed is detected in synchronization with the trigger signal which is a j·m^{th} pulse provided that j is an integer of 2 or greater after the first phase is detected; and
wherein a frequency of the trigger signal is adjusted so as to reduce a difference between the first phase and the second phase.

21. The illumination apparatus according to claim 3, further comprising:
an adjusting unit that is configured to output a driving signal for adjusting the repetition frequency of the pulsed light beam or the frequency of the sonic traveling wave so as to reduce a difference between a first phase of interference fringes and a second phase of interference fringes, the first phase of interference fringes being formed on the plane to be observed in synchronization with the pulsed light beam, the second phase of interference fringes being formed on the plane to be observed in synchronization with the pulsed light beam of a j·m^{th} pulse provided that j is an integer of 1 or greater after the first phase is detected.

22. The illumination apparatus according to claim 5, further comprising:
an adjusting unit configured to output a driving signal for adjusting the repetition frequency of the pulsed light beam or the frequency of the sonic traveling wave so as to increase contrast of integrated interference fringes obtained by detecting a plurality of interference fringes formed on the plane to be observed in synchronization with the pulsed light beam.

23. The illumination apparatus according to claim 1,
wherein a light beam emitted from the light source unit is a continuous light beam; and
wherein, in order to reduce a difference between a first phase of interference fringes and a second phase of interference fringes, the illumination apparatus comprises an adjusting unit configured to output a driving signal for adjusting a frequency of the trigger signal, the first phase of interference fringes being formed on the plane to be observed in synchronization with a trigger signal which is a frequency substantially m times a frequency of the sonic traveling wave provided that m is an integer of 2 or greater, the second phase of interference fringes being formed on the plane to be observed in synchronization with the trigger signal which is a j·m^{th} pulse provided that j is an integer of 2 or greater after the first phase is detected.
